(19) United States
(12) Patent Application Publication
(10) Pub. No.: US 2023/0232452 A1
(43) Pub. Date: Jul. 20, 2023

(54) CHANNEL ACCESS METHOD IN WIRELESS LOCAL AREA NETWORK AND RELATED APPARATUS

(71) Applicant: HUAWEI TECHNOLOGIES CO., LTD., Shenzhen (CN)

(72) Inventors: Yunbo LI, Shenzhen (CN); Ming GAN, Shenzhen (CN); Yuchen GUO, Shenzhen (CN); Yiqing LI, Shenzhen (CN); Guogang HUANG, Shenzhen (CN)

(73) Assignee: HUAWEI TECHNOLOGIES CO., LTD., Shenzhen (CN)

(21) Appl. No.: 18/185,964

(22) Filed: Mar. 17, 2023

Related U.S. Application Data
(63) Continuation of application No. PCT/CN2021/119099, filed on Sep. 17, 2021.

(30) Foreign Application Priority Data
Sep. 21, 2020 (CN) 202010998503.8

(51) Int. Cl. H04W 74/08; H04W 72/0453; H04W 74/00

(52) U.S. Cl. CPC H04W 74/0808; H04W 72/0453; H04W 74/002

(57) ABSTRACT

Embodiments of this disclosure include a channel access method in a wireless local area network (WLAN) and related apparatus. In the method, a communication device receives a first overlapping basic service set (OBSS) frame on a primary channel, determines a first channel with a busy channel state based on bandwidth information carried in the first OBSS frame, and performs channel contention when switching from the primary channel to a second channel. After the communication device backs off to 0 on the second channel, the communication device determines a third channel used for transmitting data, where the third channel does not include any sub-channel of the first channel, and the first channel includes the primary channel.

### CROSS-REFERENCE TO RELATED APPLICATIONS

This application is a continuation of International Application No. PCT/CN2021/119099, filed on Sep. 17, 2021, which claims priority to Chinese Patent Application No. 202010998503.8, filed on Sep. 21, 2020. The disclosures of the aforementioned applications are herein incorporated by reference in their entireties.

### TECHNICAL FIELD

This application generally relates to the field of wireless communication technologies, and in particular, to a channel access method in a wireless local area network (WLAN) and a related apparatus.

### BACKGROUND

The institute of electrical and electronics engineers (IEEE) 802.11 is one of the current mainstream wireless access standards and has been widely used. In the IEEE 802.11a standard, only a 20 MHz bandwidth is supported. Supported bandwidths have continuously been increased with an evolution of subsequent standards. A maximum bandwidth of 40 MHz is supported in the 802.11n standard, and a maximum bandwidth of 160 (80+80) MHz is supported in the 802.11 ac/ax standard. Regardless of how large bandwidth is used, there is only one primary 20 MHz channel in order to ensure backward compatibility in evolution processes of the standards. The primary 20 MHz channel needs to be included during the sending of data using any bandwidth. Consequently, when the only primary 20 MHz channel is busy, none of other idle secondary channels (or referred to as subordinate channels) can be used, thereby reducing system efficiency.

Currently, a maximum bandwidth supported by a latest-generation wireless fidelity (Wi-Fi) standard (namely, the 802.11be or an extremely high throughput (EHT) standard) is 320 MHz. In the EHT standard, in order to make full use of a channel, when an access point (AP) supports a large bandwidth (for example, 320 MHz), a station (STA) that supports only a small bandwidth (for example, 80 MHz) is allowed to be scheduled to a secondary channel for receiving. This is to avoid that all STAs supporting small bandwidths are gathered on a primary channel, and few or no station can perform sending or receiving on the subordinate channel. A typical transmission method on a secondary channel is as follows: each station that supports only 80 MHz is scheduled to park on a secondary 80 MHz channel in the 320 MHz channel. When the station parks on any secondary 80 MHz channel other than a primary 80 MHz channel, uplink data of the station can be scheduled by only an AP by using a trigger frame, and the station cannot actively perform channel contention and send the uplink data. Otherwise, sending end moments of data on a plurality of secondary 80 MHz channels may be different. As a result, the AP cannot perform correct parsing.

Although it is proposed in the EHT standard that a station that supports only a small bandwidth may be scheduled to a secondary channel for communication, many necessary implementation details below have not been resolved: how an AP performs channel access on a secondary channel when a primary channel is busy, to transmit data by using the secondary channel.

### SUMMARY

Embodiments of this application provide a channel access method in a wireless local area network (WLAN), and a related apparatus, so that when a primary channel is busy, a procedure of switching from the primary channel to a subordinate channel/a secondary channel for channel access can be optimized.

The following describes this application from different aspects. It should be understood that mutual reference may be made to the following implementations and beneficial effects of the different aspects.

According to a first aspect, this application provides a channel access method in a wireless local area network. The method includes: a communication device receives a first OBSS (overlapping basic service set) frame on a primary channel; and the communication device determines a first channel with a busy channel state based on bandwidth information carried in the first OBSS frame, where any sub-channel of the first channel may not be used together with a second channel; and the second channel is a channel to which the primary channel is switched. The bandwidth information is used for indicating a bandwidth of the first OBSS frame. The communication device records the bandwidth of the first OBSS frame, and the first channel is a channel corresponding to the bandwidth of the first OBSS frame. The first channel includes the primary channel.

Optionally, after or at the same time when the communication device determines a first channel with a busy channel state based on bandwidth information carried in the first OBSS frame, the communication device performs channel contention when switching from the primary channel to the second channel. After the communication device backs off to 0 on the second channel, the communication device determines a third channel used for transmitting data, where the third channel does not include any sub-channel of the first channel.

Optionally, after receiving the first OBSS frame on the primary channel, the communication device updates a first NAV (network allocation vector) on the primary channel according to a duration field in the first OBSS frame.

The second channel is a temporary primary channel, and the temporary primary channel may be negotiated in advance or specified in a standard protocol. The first channel is a channel occupied by the first OBSS frame, and includes one or more sub-channels; and a bandwidth of each sub-channel is 20 MHz.

Since each sub-channel occupied by the first OBSS frame is in a busy state, in some solutions, when the first OBSS frame is received on the primary channel, the bandwidth of the first OBSS frame is recorded, so that each sub-channel occupied by the first OBSS frame may not be used as a channel for transmitting data after the communication device backs off to 0 on the temporary primary channel. A transmission collision on each sub-channel occupied by the first OBSS frame can be reduced; a success rate of data transmission can be improved; and channel access on the secondary channel can be further improved.

According to a second aspect, this application provides a communication device or a chip in a communication device, for example, a wireless fidelity (Wi-Fi) chip. The communication device may be an access point (AP) or a station (STA). The communication device includes: a transceiver unit (e.g., transceiver circuit), configured to receive a first OBSS frame on a primary channel; and a processing unit (e.g., processing circuit), configured to determine a first channel with a busy channel state based on bandwidth information carried in the first OBSS frame, where any sub-channel of the first channel may not be used together with a second channel, and the second channel is a channel to which the communication device performs switching from the primary channel. The bandwidth information is used for indicating a bandwidth of the first OBSS frame. The processing unit is further configured to record the bandwidth of the first OBSS frame, and the first channel is a channel corresponding to the bandwidth of the first OBSS frame. The first channel includes the primary channel.

Optionally, the processing unit is further configured to perform channel contention when switching from the primary channel to the second channel, and determine, after the communication device backs off to 0 on the second channel, a third channel used for transmitting data, where the third channel does not include any sub-channel of the first channel.

Optionally, the processing unit is further configured to update a first NAV on the primary channel based on a duration field in the first OBSS frame.

The second channel is a temporary primary channel, and the temporary primary channel may be negotiated in advance or specified in a standard protocol. The first channel is a channel occupied by the first OBSS frame, and includes one or more sub-channels; and a bandwidth of each sub-channel is 20 MHz.

In an implementation of any one of the foregoing aspects, the bandwidth of the first OBSS frame is 320 MHz. The first channel is a 160 MHz channel at which a 320 MHz channel corresponding to the bandwidth of the first OBSS frame and a 320 MHz channel supported by the communication device overlap in frequency.

Since the 802.11be proposes that 320 MHz channels in a frequency band of 6 GHz may partially overlap, that is, two 320 MHz channels overlap at a 160 MHz channel therein. Therefore, some solutions provide a channel access method that is still applicable to a case where channels overlap.

According to a third aspect, this application provides a channel access method in a wireless local area network. The method includes: when a channel state of a primary channel is a busy state, a communication device performs switching from the primary channel to a second channel, and receives a second OBSS frame on the second channel, where channels corresponding to a bandwidth of the second OBSS frame include the primary channel. If a time length indicated by a duration field in the second OBSS frame is greater than a current time length of a first NAV on the primary channel, the communication device may update the first NAV based on the duration field in the second OBSS frame.

Optionally, the communication device determines that a channel state of the primary channel is a busy state, including: the communication device receives a first OBSS frame on the primary channel and updates the first NAV on the primary channel according to a duration field in the first OBSS frame.

The second channel is a temporary primary channel, and the temporary primary channel may be negotiated in advance or specified in a standard protocol.

Optionally, the first NAV is a basic NAV, that is, basic NAV.

In some solutions, when a bandwidth of a frame (that is, the second OBSS frame) for which a second NAV is set on the temporary primary channel (that is, the second channel) covers the primary channel, the first NAV on the primary channel is updated, so that a procedure of switching from the primary channel to the subordinate channel/secondary channel for channel access can be optimized.

With reference to the third aspect, in a possible implementation, after the communication device receives a second OBSS frame on the second channel, the method further includes: if a time length indicated by a duration field in the second OBSS frame is greater than a current time length of the first NAV, the communication device performs switching from the second channel back to the primary channel or to a fourth channel. The fourth channel is a temporary primary channel different from the second channel.

In some solutions, when channel busy time on a temporary primary channel (that is, the second channel) is greater than channel busy time on the primary channel, the temporary primary channel is switched back to the primary channel or to another temporary primary channel (that is, the fourth channel) to perform channel sensing and backoff. In this way, long-time waiting on the second channel can be avoided, a channel access opportunity can be improved, and a delay can be reduced.

With reference to the third aspect, in a possible implementation, after the communication device receives a second OBSS frame on the second channel, the method further includes: the communication device sets a second NAV on the second channel based on a duration field in the second OBSS frame.

Optionally, if the time length indicated by the duration field in the second OBSS frame is equal to the current time length of the first NAV, the communication device performs switching from the second channel to the primary channel or the fourth channel.

In some solutions, one NAV is also maintained on the temporary primary channel, so that when a TXOP (transmission opportunity) is obtained on the primary channel subsequently, it is conductive to determine which sub-channels can be used.

With reference to the third aspect, in a possible implementation, after the communication device sets a second NAV on the second channel based on a duration field in the second OBSS frame, the method further includes: the communication device performs switching from the second channel to a fourth channel. The fourth channel is a temporary primary channel different from the second channel.

Optionally, after the communication device obtains the TXOP from the fourth channel, end time of the TXOP on the fourth channel may not exceed end time of the TXOP on the primary channel.

In some solutions, after the second NAV on a temporary primary channel (that is, the second channel) is set/updated, the communication device performs switching from the temporary primary channel to another temporary primary channel to perform channel contention. It is not necessary to determine, according to holding time on the temporary primary channel, whether to switch to the another temporary primary channel, and it is only necessary to determine that the temporary primary channel needs to wait (that is, after the second NAV on the temporary primary channel is set/updated) for switching, which can further improve a channel access opportunity and reduce a delay.

With reference to the third aspect, in a possible implementation, when the communication device obtains the TXOP from the fourth channel, if a value of the second NAV is greater than 0, the communication device determines that channels used for transmitting data do not include any sub-channel in the channel corresponding to the bandwidth of the first OBSS frame or any sub-channel in the channel corresponding to the bandwidth of the second OBSS frame. When the communication device obtains the TXOP from the fourth channel, if a value of the second NAV is equal to 0, the communication device determines that channels used for transmitting data do not include any sub-channel in the channel corresponding to the bandwidth of the first OBSS frame.

According to a fourth aspect, this application provides a communication device or a chip in a communication device, for example, a Wi-Fi chip. The communication device may be an AP or a STA. The communication device includes: a processing unit, configured to perform, when a channel state of a primary channel is a busy state, switching from the primary channel to a second channel; and a transceiver unit, configured to receive a second OBSS frame on the second channel, where channels corresponding to a bandwidth of the second OBSS frame include the primary channel. The processing unit is further configured to update, if a time length indicated by a duration field in the second OBSS frame is greater than a current time length of a first NAV on the primary channel, the first NAV based on the duration field in the second OBSS frame.

Optionally, the transceiver unit is further configured to receive a first OBSS frame on the primary channel. The processing unit is further configured to update the first NAV on the primary channel based on a duration field in the first OBSS frame.

The second channel is a temporary primary channel, and the temporary primary channel may be negotiated in advance or specified in a standard protocol.

Optionally, the first NAV is a basic NAV, that is, basic NAV.

With reference to the fourth aspect, in a possible implementation, the processing unit is further configured to perform switching from the second channel to the primary channel or to a fourth channel. The fourth channel is a temporary primary channel different from the second channel.

With reference to the fourth aspect, in a possible implementation, the processing unit is further configured to: set a second NAV on the second channel based on the duration field in the second OBSS frame; and perform switching from the second channel to the primary channel or a fourth channel when the time length indicated by the duration field in the second OBSS frame is equal to the current time length of the first NAV.

With reference to the fourth aspect, in a possible implementation, the processing unit is further configured to perform switching from the second channel to a fourth channel. After the TXOP is obtained on the fourth channel, end time of the TXOP on the fourth channel may not exceed end time of a TXOP on the primary channel. The fourth channel is a temporary primary channel different from the second channel.

With reference to the fourth aspect, in a possible implementation, the processing unit is further configured to: when obtaining the TXOP on the fourth channel, determine, if a value of the second NAV is greater than 0, that channels used for transmitting data do not include any sub-channel in the channel corresponding to the bandwidth of the first OBSS frame or any sub-channel in the channel corresponding to the bandwidth of the second OBSS frame; and when obtaining the TXOP on the fourth channel, determine, if a value of the second NAV is equal to 0, that channels used for transmitting data do not include any sub-channel in the channel corresponding to the bandwidth of the first OBSS frame.

According to a fifth aspect, this application provides a channel access method in a wireless local area network. The method includes: when a channel state of a primary channel is a busy state, a communication device performs switching from the primary channel to a second channel, and determines a value of a CW (contention window) and an initial value of a BOC (backoff counter) on the second channel. The value of the CW on the second channel is equal to a current value of a CW on the primary channel, and the initial value of the BOC on the second channel is equal to a current value of a BOC on the primary channel. Alternatively, the value of the CW on the second channel is a minimum CW value, that is, CWmin, and the initial value of the BOC on the second channel is an integer selected from 0 to CWmin.

Optionally, that a channel state of a primary channel is a busy state includes: the communication device receives a first OBSS frame on the primary channel, and updates a first NAV on the primary channel based on a duration field in the first OBSS frame. Alternatively, a result of energy detection performed by the communication device on the primary channel is a busy state.

The second channel is a temporary primary channel, and the temporary primary channel may be negotiated in advance or specified in a standard protocol.

In some solutions, the manner of determining the CW and the BOC on the temporary primary channel in the process of performing the channel contention on the temporary primary channel can improve a channel access flow on the secondary channel.

According to a sixth aspect, this application provides a communication device or a chip in a communication device, for example, a Wi-Fi chip. The communication device may be an AP or a STA. The communication device includes: a processing unit, configured to perform, when a channel state of a primary channel is a busy state, switching from the primary channel to a second channel, and determine a value of a CW and an initial value of a BOC on the second channel. The value of the CW on the second channel is equal to a current value of a CW on the primary channel, and the initial value of the BOC on the second channel is equal to a current value of a BOC on the primary channel. Alternatively, the value of the CW on the second channel is CWmin, and the initial value of the BOC on the second channel is an integer selected from 0 to CWmin.

Optionally, the communication device may further include a transceiver unit, configured to receive a first OBSS frame on the primary channel. The processing unit is further configured to update the first NAV on the primary channel based on a duration field in the first OBSS frame.

Optionally, a result of energy detection performed by the processing unit on the primary channel is a busy state.

The second channel is a temporary primary channel, and the temporary primary channel may be negotiated in advance or specified in a standard protocol.

According to a seventh aspect, this application provides a channel access method in a wireless local area network. The method includes: after being switched from a second channel back to a primary channel, a communication device performs energy detection on the primary channel; and if a result of the energy detection on the primary channel within a first time is a busy state, the communication device performs first processing on the primary channel. The first processing may include: performing channel contention at an interval of a second time after the channel state of the primary channel changes from the busy state to an idle state; or setting, within preset time, an energy detection threshold used for clear channel assessment (CCA) on the primary channel to be a value less than -62 dBm, for example, -82 dBm, and sending an RTS (request to send) frame after a backoff counter on the primary channel backs off to 0.

Optionally, before the communication device performs switching from the second channel back to the primary channel, the method further includes: the communication device receives a first OBSS frame on the primary channel, and updates a first NAV on the primary channel based on a duration field in the first OBSS frame. The communication device performs switching from the primary channel to the second channel.

The first time may start from the switching from the second channel back to the primary channel until the end of a point coordination function interframe space when the first NAV on the primary channel decreases to 0. The second time may be an extended interframe space.

The second channel is a temporary primary channel, and the temporary primary channel may be negotiated in advance or specified in a standard protocol.

Optionally, the first NAV is a basic NAV.

In some solutions, when the channel state of the primary channel is the busy state after the switching back to the primary channel, the energy detection threshold used for the clear channel assessment on the primary channel is reduced, and the RTS frame is sent, after the backoff counter backs off to 0 on the primary channel, to perform channel protection, so that an OBSS frame that may be being transmitted on the primary channel can be protected, a collision probability can be reduced, and a channel access flow on the primary channel in different cases can be improved.

With reference to the seventh aspect, in a possible implementation, the method further includes: if time at which the communication device performs switching from the second channel back to the primary channel is later than time at which the first NAV on the primary channel changes to 0, the communication device performs the first processing on the primary channel.

In some solutions, when the time of the switching back to the primary channel is later than the time at which the NAV on the primary channel decreases to 0, the energy detection threshold used for the clear channel assessment on the primary channel is reduced and the RTS frame is sent to perform the channel protection after the backoff counter backs off to 0 on the primary channel, so that the OBSS frame that may be being transmitted on the primary channel can be protected, and a collision probability can be reduced.

According to an eighth aspect, this application provides a communication device or a chip in a communication device, for example, a Wi-Fi chip. The communication device may be an AP or a STA. The communication device includes: a processing unit, configured to perform energy detection on the primary channel after switching from a second channel back to a primary channel; and perform first processing on the primary channel if a result of the energy detection on the primary channel within a first time is a busy state. The first processing includes: performing channel contention at an interval of a second time after the channel state of the primary channel changes from the busy state to an idle state; or setting, within preset time, an energy detection threshold used for CCA on the primary channel to be a value less than -62 dBm, and sending an RTS frame after a backoff counter on the primary channel backs off to 0.

Optionally, the communication apparatus may further include a transceiver unit, configured to receive a first OBSS frame on the primary channel. The processing unit is further configured to update a first NAV on the primary channel based on a duration field in the first OBSS frame.

The first time may start from the switching from the second channel back to the primary channel until the end of a point coordination function interframe space when the first NAV on the primary channel decreases to 0. The second time may be an extended interframe space.

The second channel is a temporary primary channel, and the temporary primary channel may be negotiated in advance or specified in a standard protocol.

Optionally, the first NAV is a basic NAV.

With reference to the eighth aspect, in a possible implementation, the processing unit is further configured to perform the first processing on the primary channel if time of switching from the second channel back to the primary channel is later than time at which the first NAV on the primary channel changes to 0.

According to a ninth aspect, this application provides a channel access method in a wireless local area network. The method includes: when a result of energy detection performed by a communication device on a primary channel is a busy state, the communication device performs switching from the primary channel to a second channel. The second channel is a temporary primary channel, and the temporary primary channel may be negotiated in advance or specified in a standard protocol.

In some solutions, when it is detected, by using the energy detection, that the primary channel is busy, the communication device can be switched to a temporary primary channel to perform channel contention, so as to improve a channel access opportunity.

With reference to the ninth aspect, in a possible implementation, time at which the communication device leaves the primary channel does not exceed a third time. The third time does not exceed an extreme time length of the TXOP, that is, a TXOP limit, or a maximum physical layer protocol data unit (PPDU) length.

In some solutions, maximum time for leaving the primary channel is restricted, so that the communication device can be switched back to the primary channel in relatively short time to perform the channel contention, thereby optimizing the procedure of the switching from the primary channel to the secondary channel for channel access.

With reference to the ninth aspect, in a possible implementation, the method further includes: if time at which the communication device leaves the primary channel exceeds a fourth time, after the communication device performs switching from the second channel back to the primary channel, the communication device sets, within preset time, an energy detection threshold used for CCA on the primary channel to be a value less than -62 dBm, and sends an RTS frame after a backoff counter on the primary channel backs off to 0.

In some solutions, after the time for leaving the primary channel exceeds suggested time, a collision probability can be reduced to protect an OBSS frame that may be being transmitted on the primary channel and reduce the energy detection threshold.

With reference to the ninth aspect, in a possible implementation, the method further includes: if time at which the communication device leaves the primary channel exceeds a fourth time and does not exceed a third time, after the communication device performs switching from the second channel back to the primary channel, the communication device sets, within a preset time, an energy detection threshold used for CCA on the primary channel to be a value less than -62 dBm, and sends an RTS frame after a backoff counter on the primary channel backs off to 0.

In any implementation of the ninth aspect, time of stay after the communication device leaves the primary channel starts from the time at which the communication device leaves the primary channel and ends at the time at which the communication device performs switching back to the primary channel.

According to a tenth aspect, this application provides a communication device or a chip in a communication device, for example, a Wi-Fi chip. The communication device may be an AP or a STA. The communication device includes a processing unit, configured to perform switching from the primary channel to a second channel when a result of energy detection performed on the primary channel is a busy state. The second channel is a temporary primary channel, and the temporary primary channel may be negotiated in advance or specified in a standard protocol.

With reference to the tenth aspect, in a possible implementation, time for leaving the primary channel does not exceed a third time. The third time does not exceed a TXOP limit or a maximum PPDU length.

With reference to the tenth aspect, in a possible implementation, the processing unit is further configured to: when the time for leaving the primary channel exceeds a fourth time, after the switching from the second channel back to the primary channel, set, within a preset time, an energy detection threshold used for CCA on the primary channel to be a value less than -62 dBm, and send an RTS frame after a backoff counter on the primary channel backs off to 0.

With reference to the tenth aspect, in a possible implementation, the processing unit is further configured to: when time for leaving the primary channel exceeds a fourth time and does not exceed a third time, set, within preset time after the switching from the second channel back to the primary channel, an energy detection threshold used for CCA on the primary channel to be a value less than -62 dBm, and send an RTS frame after a backoff counter on the primary channel backs off to 0.

In any implementation of the tenth aspect, time for leaving the primary channel starts from the time for leaving the primary channel and ends at the time of the switching back to the primary channel.

According to an eleventh aspect, an embodiment of this application provides a communication device, including a processor. Optionally, the device further includes a transceiver. In a possible design, a transceiver is configured to receive a first OBSS frame on a primary channel. The processor is configured to determine a first channel with a busy channel state based on bandwidth information carried in the first OBSS frame, where any sub-channel of the first channel may not be used together with a second channel, and the second channel is a channel to which the primary channel is switched. The bandwidth information is used for indicating a bandwidth of the first OBSS frame. The processor is further configured to record the bandwidth of the first OBSS frame, and the first channel is a channel corresponding to the bandwidth of the first OBSS frame. The first channel includes the primary channel.

In a possible design, the processor is configured to perform, when it is determined that a channel state of a primary channel is a busy state, switching from the primary channel to a second channel; the transceiver is configured to receive a second OBSS frame on the second channel, where channels corresponding to a bandwidth of the second OBSS frame include the primary channel; and the processor is further configured to update, if a time length indicated by a duration field in the second OBSS frame is greater than a current time length of a first NAV on the primary channel, the first NAV based on the duration field in the second OBSS frame.

In a possible design, the processor is configured to perform, when a channel state of a primary channel is a busy state, switching from the primary channel to a second channel, and determine a value of a CW and an initial value of a BOC on the second channel. The value of the CW on the second channel is equal to a current value of a CW on the primary channel, and the initial value of the BOC on the second channel is equal to a current value of a BOC on the primary channel. Alternatively, the value of the CW on the second channel is CWmin, and the initial value of the BOC on the second channel is an integer selected from 0 to Cwmin.

In a possible design, the processor is configured to perform energy detection on the primary channel after switching from a second channel back to a primary channel, where the second channel is a channel to which the primary channel is switched; and perform first processing on the primary channel when an energy detection result on the primary channel within a first time is a busy state. The first processing includes: performing channel contention at an interval of a second time after the channel state of the primary channel changes from the busy state to an idle state; or setting, within a preset time, an energy detection threshold used for CCA on the primary channel to be a value less than -62 dBm, and sending an RTS frame after a backoff counter on the primary channel backs off to 0.

In a possible design, the processor is configured to perform, when a result of the energy detection performed on the primary channel is a busy state, switching from the primary channel to a second channel, and perform channel contention on the second channel. The processor is further configured to perform switching back to the primary channel within a third time. Alternatively, the processor is further configured to: when time for leaving the primary channel exceeds a fourth time, set, within a preset time after the switching from the second channel back to the primary channel, an energy detection threshold used for CCA on the primary channel to be a value less than -62 dBm, and send an RTS frame after a backoff counter on the primary channel backs off to 0. Alternatively, the processor is further configured to: when time for leaving the primary channel exceeds a fourth time and does not exceed a third time, set, within a preset time after the switching from the second channel back to the primary channel, an energy detection threshold used for CCA on the primary channel to be a value less than -62 dBm, and send an RTS frame after a backoff counter on the primary channel backs off to 0. The second channel is a temporary primary channel, and the temporary primary channel may be negotiated in advance or specified in a standard protocol.

According to a twelfth aspect, this application provides a communication device. The communication device may exist in a product form of a chip, and a structure of the communication device includes an input/output interface and a processing circuit. In a possible design, the input/output interface is configured to receive the first OBSS frame received by a transceiver from a primary channel. The processing circuit is configured to determine a first channel with a busy channel state based on bandwidth information carried in the first OBSS frame, where any sub-channel of the first channel may not be used together with a second channel, and the second channel is a channel to which the primary channel is switched. The first channel includes the primary channel.

In a possible design, the processor is configured to perform, when a channel state of a primary channel is a busy state, switching from the primary channel to a second channel. The input/output interface is configured to receive the second OBSS frame received by the transceiver from the second channel. The processing circuit is further configured to update, if a time length indicated by a duration field in the second OBSS frame is greater than a current time length of a first NAV on the primary channel, the first NAV based on the duration field in the second OBSS frame.

In a possible design, the processing circuit is configured to perform, when a channel state of a primary channel is a busy state, switching from the primary channel to a second channel, and determine a value of a CW and an initial value of a BOC on the second channel. The value of the CW on the second channel is equal to a current value of a CW on the primary channel, and the initial value of the BOC on the second channel is equal to a current value of a BOC on the primary channel. Alternatively, the value of the CW on the second channel is a minimum CW value CWmin, and the value of the BOC on the second channel is an integer selected from 0 to CWmin.

In a possible design, the processing circuit is configured to perform, when a channel state of a primary channel is a busy state, switching from the primary channel to a second channel, and determine a value of a CW and an initial value of a BOC on the second channel. The value of the CW on the second channel is equal to a current value of a CW on the primary channel, and the initial value of the BOC on the second channel is equal to a current value of a BOC on the primary channel. Alternatively, the value of the CW on the second channel is a minimum CW value CWmin, and the value of the BOC on the second channel is an integer selected from 0 to CWmin.

In a possible design, the processing circuit is configured to perform switching from the primary channel to the second channel when a result of energy detection performed on the primary channel is in a busy state. The processing circuit is further configured to perform switching back to the primary channel within a third time. Alternatively, the processing circuit is further configured to: when time for leaving the primary channel exceeds a fourth time, set, within a preset time after the switching from the second channel back to the primary channel, an energy detection threshold used for CCA on the primary channel to be a value less than -62 dBm, and send an RTS frame after a backoff counter on the primary channel backs off to 0. Alternatively, the processing circuit is further configured to: when time for leaving the primary channel exceeds a fourth time and does not exceed a third time, set, within preset time after the switching from the second channel back to the primary channel, an energy detection threshold used for CCA on the primary channel to be a value less than -62 dBm, and send an RTS frame after a backoff counter on the primary channel backs off to 0.

According to a thirteenth aspect, this application provides a computer-readable storage medium. The computer-readable storage medium stores program instructions. When the program instructions are run on a computer, the computer is enabled to perform the method according to the first aspect, the third aspect, the fifth aspect, the seventh aspect, or the ninth aspect.

According to a fourteenth aspect, this application provides a computer program product including program instructions. When the computer program product is run on a computer, the computer is enabled to perform the method according to the first aspect, the third aspect, the fifth aspect, the seventh aspect, or the ninth aspect.

According to the implementation of embodiments of this application, when a primary channel is busy, a procedure of switching from the primary channel to a subordinate channel/a secondary channel for channel access can be optimized.

### BRIEF DESCRIPTION OF DRAWINGS

To describe the technical solutions in embodiments of this application more clearly, the following briefly describes the accompanying drawings used for describing the embodiments.

FIG. 1 is a schematic diagram of a system architecture of a wireless local area network (WLAN) according to an embodiment of this application;

FIG. 2a is a schematic diagram depicting a structure of an access point (AP) according to an embodiment of this application;

FIG. 2b is a schematic diagram depicting a structure of a station (STA) according to an embodiment of this application;

FIG. 3a is a schematic diagram of channel division of a 320 MHz channel according to an embodiment of this application;

FIG. 3b is another schematic diagram of channel division of a 320 MHz channel according to an embodiment of this application;

FIG. 4 is a first schematic flowchart of a channel access method in a WLAN according to an embodiment of this application;

FIG. 5 is a schematic diagram of channel contention on a temporary primary channel according to an embodiment of this application;

FIG. 6 is a second schematic flowchart of a channel access method in a WLAN according to an embodiment of this application;

FIG. 7 is a third schematic flowchart of a channel access method in a WLAN according to an embodiment of this application;

FIG. 8 is a fourth schematic flowchart of a channel access method in a WLAN according to an embodiment of this application;

FIG. 9 is a fifth schematic flowchart of a channel access method in a WLAN according to an embodiment of this application; and

FIG. 10 is a schematic diagram depicting a structure of a communication device provided according to an embodiment of this application.

### DESCRIPTION OF EMBODIMENTS

The following describes technical solutions in embodiments of this application with reference to accompanying drawings in embodiments of this application.

Embodiments of this application provide a channel access method in a wireless local area network (WLAN), to improve a procedure of switching from a primary channel to a subordinate channel/a secondary channel for channel access when the primary channel is busy, and implement a solution that an access point (AP) schedules some stations to the secondary channel for communication. The channel access method may be implemented by a communication device in the wireless local area network or a chip or a processor in a communication device. The communication device may be an AP device or a station (STA) device. Alternatively, the communication device may be a wireless communication device that supports parallel transmission on a plurality of links. For example, the communication device may be referred to as a multi-link device (MLD) or a multi-band device. The channel access method may be implemented by one functional entity or functional unit in the multi-link device. Compared with a communication device that supports only single-link transmission, the multi-link device has higher transmission efficiency and a larger throughput rate.

The following briefly describes a system architecture of the wireless local area network provided in embodiments of this application.

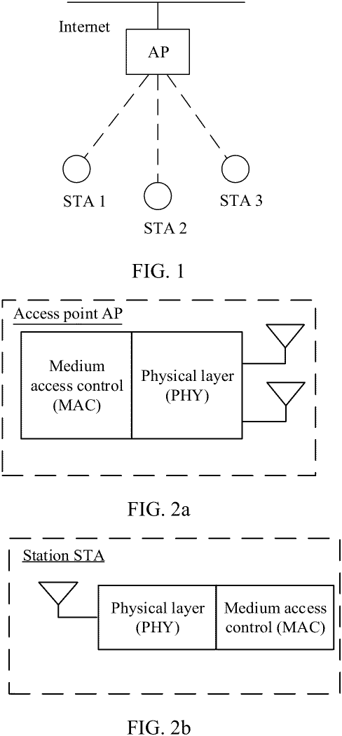

Refer to FIG. 1. FIG. 1 is a schematic diagram of a system architecture of a wireless local area network according to an embodiment of this application. As shown in FIG. 1, the wireless local area network may include one AP and one or more stations (for example, a STA 1, a STA 2, and a STA 3 in FIG. 1). The AP may access the internet in a wired or wireless manner. The AP may be associated with a plurality of STAs, and uplink and downlink communication may be performed between the AP and the plurality of STAs associated with the AP by using the 802.11 protocol. The 802.11 protocol may include IEEE 802.11be (or referred to as a Wi-Fi 7, extremely high throughput (EHT) protocol), and may further include protocols such as IEEE 802.11ax and IEEE 802.11ac. Of course, with continuous evolution and development of communication technologies, the 802.11 protocol may further include a next-generation protocol of the IEEE 802.11be. An apparatus for implementing the method of this application may be an AP or a STA in the WLAN, or a chip or a processing system installed in the AP or the STA.

The AP is an apparatus having a wireless communication function, supports communication by using a WLAN protocol, has a function of communicating with another device (for example, a station or another access point) in a WLAN network, and of course, may further have a function of communicating with another device. In a WLAN system, an access point may be referred to as an access point station (AP STA). The apparatus having a wireless communication function may be an entire device, or may be a chip or a processing system installed in an entire device. A device in which the chip or the processing system is installed may implement the method and the function in embodiments of this application under control of the chip or the processing system. The AP in embodiments of this application is an apparatus that provides a service for a STA, and may support the 802.11 series protocols. For example, the AP may be a communication entity, for example, a communication server, a router, a switch, or a bridge. The AP may include a macro base station, a micro base station, a relay station, and the like in various forms. Certainly, the AP may alternatively be a chip or a processing system in these devices in various forms, to implement the method and the function in embodiments of this application.

The station (for example, the STA 1, the STA 2 and the STA 2 in FIG. 1) is an apparatus having a wireless communication function, supports communication by using a WLAN protocol, and has a capability of communicating with other stations or access points in a WLAN. In a WLAN system, the station may be referred to as a non-access point station (non-access point station, non-AP STA). For example, the STA is any user communication device that allows a user to communicate with an AP and further communicate with a WLAN. The apparatus having a wireless communication function may be an entire device, or may be a chip or a processing system installed in an entire device. A device in which the chip or the processing system is installed may implement the method and the function in embodiments of this application under control of the chip or the processing system. For example, the STA may be user equipment that can connect to the internet, for example, a tablet computer, a desktop computer, a laptop computer, a notebook computer, an ultra-mobile personal computer (UMPC), a handheld computer, a netbook, a personal digital assistant (PDA), or a mobile phone. Alternatively, the STA may be an internet of things (IoT) node in the IoT, an in-vehicle communication apparatus in the internet of vehicles, an entertainment device, a game device or system, a global positioning system device, or the like. The STA may alternatively be a chip and a processing system in the foregoing terminals.

The WLAN system can provide high-speed and low-latency transmission. With continuous evolution of WLAN application scenarios, the WLAN system is to be applied to more scenarios or industries, for example, the internet of things industry, the internet of vehicles industry, the banking industry, enterprise offices, exhibition halls of stadiums, concert halls, hotel rooms, dormitories, wards, classrooms, supermarkets, squares, streets, production workshops and warehousing. Certainly, a device (such as an access point or a station) that supports WLAN communication may be a sensor node (for example, a smart water meter, a smart electricity meter, or a smart air detection node) in smart city, a smart device (for example, a smart camera, a projector, a display, a television, a stereo, a refrigerator, or a washing machine) in smart home, a node in the IoT, an entertainment terminal (for example, an artificial reality (AR), a virtual reality (VR), or another wearable device), a smart device in smart office (for example, a printer, a projector, a loudspeaker, or a stereo), an internet of vehicles device in the internet of vehicles, an infrastructure (for example, a vending machine, a self-service navigation station of a supermarket, a self-service cash register device, or a self-service ordering machine) in daily life scenarios, a device in a large sports and music venue, and the like. Specific forms of the STA and the AP are not limited in embodiments of this application, and are merely examples for description herein.

Optionally, FIG. 1 is merely a schematic diagram. In addition to application to a scenario in which an AP communicates with one or more STAs, the channel access method in the wireless local area network provided in some embodiments may be further applied to a scenario in which an AP communicates with another AP, and is also applicable to a scenario in which a STA communicates with another STA.

Optionally, refer to FIG. 2a. FIG. 2a is a schematic diagram of a structure of an AP according to an embodiment of this application. The AP may have a plurality of antennas, or may have a single antenna. In FIG. 2a, the AP includes a physical layer (PHY) processing circuit and a media access control (MAC) processing circuit. The physical layer processing circuit may be configured to process a physical layer signal, and the MAC layer processing circuit may be configured to process a MAC layer signal. The 802.11 standard focuses on the PHY and the MAC. Refer to FIG. 2b. FIG. 2b is a schematic diagram of a structure of a station according to an embodiment of this application. FIG. 2b is a schematic diagram of a structure of a STA with a single antenna. In an actual scenario, the STA may alternatively have a plurality of antennas, and may be a device with more than two antennas. In FIG. 2b, the STA may include a PHY processing circuit and a MAC processing circuit. The physical layer processing circuit may be configured to process a physical layer signal, and the MAC layer processing circuit may be configured to process a MAC layer signal.

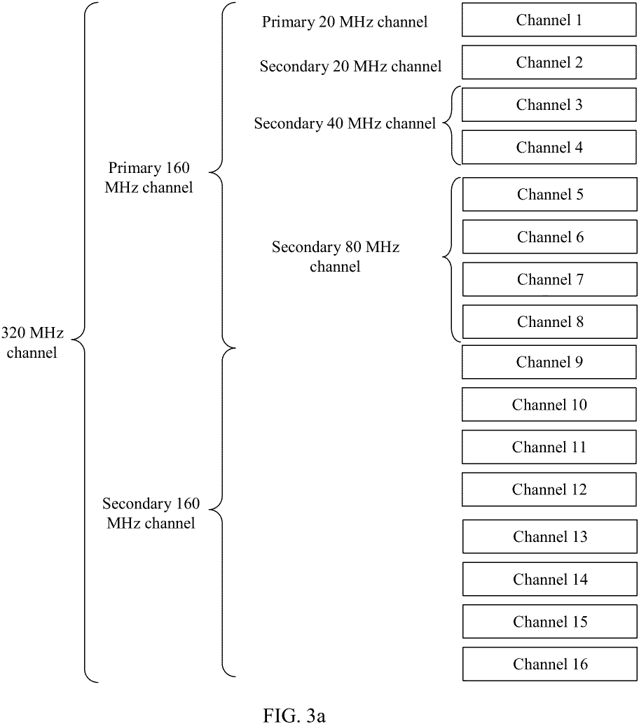

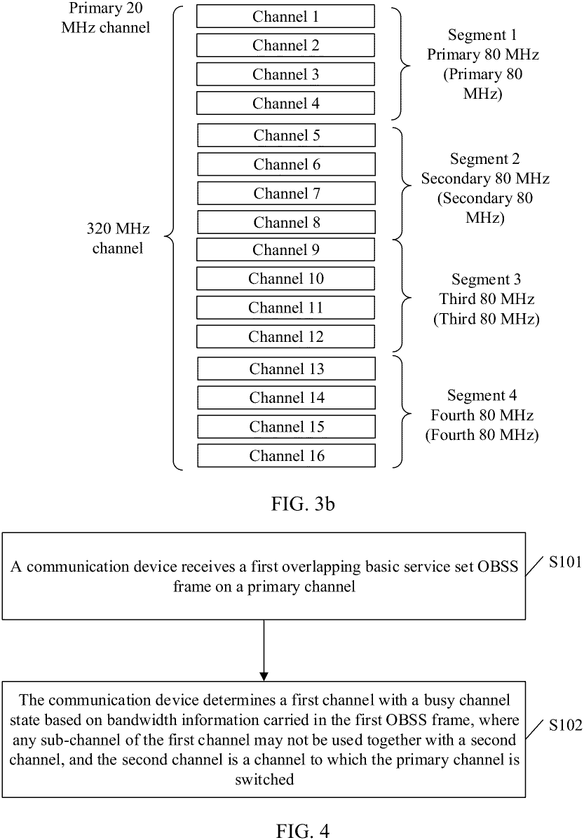

In a WLAN, channels are usually classified into a primary channel and a secondary channel, and the secondary channel may include one or more sub-channels. In an example, if division is performed by using 20 MHz as a basic bandwidth unit, when a bandwidth of a channel is 20 MHz, the channel includes only one primary channel with a bandwidth of 20 MHz; or when a bandwidth of a channel is greater than 20 MHz, the channel includes one primary channel with a bandwidth of 20 MHz, and one or more secondary channels of 20 MHz. Refer to FIG. 3a. FIG. 3a is a schematic diagram of channel division of a 320 MHz channel according to an embodiment of this application. As shown in FIG. 3a, the 320 MHz channel includes a primary 160 MHz channel and a secondary 160 MHz channel. The 320 MHz channel is sequentially numbered as a channel 1 to a channel 16, and each number represents a 20 MHz channel. The channel 1 represents a primary 20 MHz channel (primary 20 MHz channel, P20 for short), and the channel 2 represents a secondary 20 MHz channel (secondary 20 MHz channel, S20 for short). One secondary 40 MHz channel (secondary 40 MHz channel, S40 for short) includes two sub-channels with bandwidths of 20 MHz: the channel 3 and the channel 4. One secondary 80 MHz channel (secondary 80 MHz channel, S80 for short) includes four sub-channels with bandwidths of 20 MHz: channels 5, 6, 7, and 8. The channels 5 and 6, the channels 6 and 7, and the channels 7 and 8 are neighboring respectively. One primary 160 MHz channel includes the channels 1 to 8, and one secondary 160 MHz channel includes the channels 9 to 16. It can be understood that one secondary 160 MHz channel means that a bandwidth of the secondary channel is 160 MHz, and one primary 160 MHz channel means that a bandwidth of the primary channel is 160 MHz. In some embodiments, the secondary channel may also be referred to as a subordinate channel, and the secondary 160 MHz channel may also be referred to as a subordinate 160 MHz channel. The primary channel is a common channel of operation for STAs that are members of a basic service set (The common channel of operation for STAs that are members of the basic service set (BSS)). A station in the BSS may perform channel contention on a primary channel, so as to preempt channel resources. For example, as shown in FIG. 1, the STA 1, the STA 2, the STA 3, or an AP in the BSS may perform channel contention on the channel 1, so as to preempt channel resources.

In one example, the channels 1 to 16 may be arranged in a manner shown in FIG. 3a, or in various other manners. This is not limited in this application. For ease of description, in all embodiments of this application, for the channel division in the WLAN, the channel 1 is used as the primary channel. It should be noted that the 802.11 system supports channel bandwidths of different sizes, and the channel may be contiguous bandwidths of 20 MHz, 40 MHz, 80 MHz, and 160 MHz, a noncontiguous bandwidth of 80 MHz+80 MHz, 320 MHz, 240 MHz+80 MHz, 160 MHz+160 MHz, or the like. In a next-generation 802.11 standard, the channel bandwidth may alternatively be another bandwidth. Optionally, a channel division method thereof may be similar to that of the foregoing 320 MHz channel, and details are not described herein again.

In a WLAN, a contiguous spectrum block for transmission may be referred to as a frequency segment. One WLAN channel may include a plurality of frequency segments, and a bandwidth of each frequency segment may be 80 MHz, 40 MHz, 20 MHz, or 160 MHz. Refer to FIG. 3b. FIG. 3b is another schematic diagram of channel division of a 320 MHz channel according to an embodiment of this application. As shown in FIG. 3b, that a bandwidth of a segment is 80 MHz is taken as an example. The 320 MHz channel shown in FIG. 3b may be divided into four segments. A frequency segment may alternatively be referred to as a frequency fragment, or referred to as a fragment or segment for short.

In some embodiments, there is at least one specific secondary channel. When the communication device receives an overlapping basic service set (OBSS) frame on the primary channel and sets a network allocation vector (NAV), a communication device (the AP or the STA) may perform switching from the primary channel to a specific secondary channel to perform channel sensing and backoff. In this application, the specific secondary channel is referred to as a temporary primary channel. The temporary primary channel may also be referred to as a parking channel, a frame receiving channel, a standby channel, or other names in this application. For ease of description, the temporary primary channel is collectively used for description below. The temporary primary channel may be temporarily used as a working channel of the station, and the station may park on (e.g., parking on) or be operated on (e.g., operated on) the temporary primary channel to receive signaling or data. A position of the temporary primary channel may be predefined. For example, each of the segments 2, 3, and 4 in FIG. 3b may have one temporary primary channel, and the temporary primary channels are first 20 MHz channels of the segments 2, 3, and 4.

After the temporary primary channel is idle and a value of a backoff counter on the temporary primary channel decreases to 0, the communication device (the AP or the STA) may send a frame on a bandwidth including the temporary primary channel. When the communication device (the AP or the STA) performs the switching to the temporary primary channel, there is no NAV information on the temporary primary channel. Therefore, when the communication device performs clear channel assessment (CCA) on the temporary primary channel, an energy detection threshold (or referred to as an energy detection threshold) used for the CCA can be reduced. For example, the energy detection threshold used for the CCA is reduced from -62 dBm to -82 dBm. In this way, potential OBSS transmission can be better protected. In addition, in order to further avoid a collision caused by hidden nodes, after completing backoff on the temporary primary channel, the communication device needs to use a request to send (RTS)/clear to send (CTS) frame interaction to obtain a transmission opportunity (TXOP). If the RTS/CTS interaction fails, the number of retransmissions can be limited.

Optionally, when performing the channel contention on the temporary primary channel, the communication device needs to perform switching back to the primary channel before or when the NAV of the primary channel decreases to 0.

It can be understood that the NAV may be understood as a backoff timer, and gradually decreases as time passes. When the backoff timer displays 0, it is considered that a medium is in an idle state. Specifically, after one station receives one frame, if a receiving address of the frame is not the station and a value of a duration field in the frame is greater than a current value of the NAV of the station, the station may update the NAV according to the duration field in the received frame. If a receiving address of the frame is the station, which indicates that the station is a receiving station, or a value of a duration field in the frame is less than or equal to a current value of the NAV of the station, the NAV cannot be updated. The value of the NAV starts from an end moment of the received frame.

It may be understood that the CCA includes packet detection and energy detection. Packet detection is to detect whether a data packet is transmitted on the channel (whether a data packet is transmitted may be determined by detecting whether a packet header exists). If a data packet exists on the channel and energy exceeds a packet detection threshold, the channel is considered busy. Energy detection is to detect energy on a channel. If energy on a channel is greater than or equal to an energy detection threshold, the channel is considered busy. Only when both results of packet detection and energy detection indicate that the channel is idle, the channel is considered to be in an idle state. In other words, if no packet header is detected in a time period, and energy on the channel is less than the energy detection threshold during energy detection, the channel is considered to be in an idle state. The “energy detection” separately mentioned below in this application is performed when no packet header is detected. In other words, when a result of the “energy detection” separately mentioned below in this application is that a channel is idle, it indicates that the channel is in an idle state.

The foregoing content provides a method, in which, channel contention may be performed on a temporary primary channel when a primary channel is occupied by OBSS frame transmission, so as to transmit data by using a secondary channel. However, the method lacks some necessary implementation details, for example, how to determine which secondary channels can be used together with a temporary primary channel; how to perform channel contention when a channel state of the primary channel is a busy state after the communication device performs switching from the temporary primary channel back to the primary channel; and how to affect the primary channel after an OBSS frame is received on the temporary primary channel and an NAV is set on the temporary primary channel.

Therefore, embodiments of this application provide a channel access method in a wireless local area network, so that when a primary channel is occupied by OBSS frame transmission, a procedure of switching from the primary channel to a secondary channel for channel access can be optimized, and a solution that an AP schedules some stations to the secondary channel for communication can be implemented.

The following describes technical solutions provided by this application in detail with reference to accompanying drawings.

The technical solutions provided in this application are described in five embodiments. Embodiment I describes how to determine which sub-channels can be used together with a temporary primary channel after an OBSS frame is received on a primary channel. Embodiment II describes an impact on an NAV on a primary channel when a bandwidth of a frame for setting an NAV on a temporary primary channel covers the primary channel. Embodiment III describes how to generate and maintain values of a contention window (CW) and a backoff counter (BOC) on a temporary primary channel when channel contention is performed by switching from a primary channel to the temporary primary channel. Embodiment IV describes how to perform channel contention on a primary channel if a channel state of the primary channel is a busy state after a communication device performs switching from a temporary primary channel back to the primary channel. Embodiment V describes how a communication device determines when to perform switching back to a primary channel, that is, how long the communication device can park on a temporary primary channel, if busyness on the primary channel is caused only by energy detection of CCA (for example, if a value of energy detection on the primary channel is greater than -62 dBm, it indicates that the primary channel is busy).

The following separately describes Embodiment I to Embodiment V in detail. It may be understood that any combination of the technical solutions described in Embodiment I to Embodiment V of this application may form a new embodiment.

It may be understood that the communication device in this application may be an access point or a station. The access point and the station may be single-link device, or may be a functional entity or a functional unit in a multi-link device. For example, the access point in this application is an AP in a multi-link AP device, and the station is a STA in a multi-link station device. This is not limited in this application.

Optionally, an application scenario of some embodiments is a downlink communication scenario between an AP and a STA or a scenario in which an AP schedules a STA to perform uplink communication. For example, the AP obtains a TXOP by using channel contention, and then sends a downlink frame to one or more STAs within TXOP time; or the AP triggers, by using a trigger frame, one or more STAs to send uplink data.

### Embodiment I

Embodiment I of this application describes how to determine which sub-channels cannot be used together with a temporary primary channel after an OBSS frame is received on a primary channel. Specifically, when an OBSS frame is received on a primary channel, a bandwidth of the OBSS frame is recorded, and channels corresponding to the bandwidth of the OBSS frame are not allowed to be used/transmitted together with a temporary primary channel.

In the 802.11ax standard and earlier standards, when the primary channel is in a busy state, a secondary channel is not allowed to be used. Therefore, during setting of an NAV, a channel bandwidth occupied by a frame for setting the NAV is not considered, and it is unnecessary to obtain or record the bandwidth occupied by the frame for setting the NAV. However, in some embodiments, when the primary channel is in the busy state, the secondary channel needs to be further used. Therefore, in some embodiments, the bandwidth of the OBSS frame received on the primary channel may be recorded, and sub-channels occupied by the OBSS frame are not allowed to be used/transmitted together with a temporary primary channel.

In addition, in the 802.11ax standard and earlier standards, when the NAV on the primary channel is updated, a bandwidth used by a frame for updating the NAV is not considered. Therefore, when the bandwidths of the two frames for setting the NAV for the first time and subsequently updating the NAV are different, the bandwidth of the frame for setting the NAV for the first time will be ignored. For example, an OBSS frame with a bandwidth of 80 MHz is first received, and a time length indicated by a duration field thereof is 2 ms. An OBSS frame with bandwidth of 20 MHz is received, and a duration field thereof is 4 ms. When the NAV is updated, the 80 MHz of the OBSS frame for setting the NAV for the first time will be ignored. As a result, some sub-channels occupied by the OBSS frame are incorrectly detected as being in an idle state.

In an implementation, some embodiments provides that one NAV is maintained for each bandwidth in the communication device. That is, one NAV is maintained for each of a bandwidth of 20 MHz, a bandwidth of 40 MHz, a bandwidth of 80 MHz, a bandwidth of 160 MHz and a bandwidth of 320 MHz. In the channel contention process of switching from the primary channel to the temporary primary channel, before values of NAVs with different bandwidths on the primary channel decrease to 0, sub-channels on the corresponding bandwidths cannot be used for data transmission.

In another implementation, in order to simplify maintenance complexity of a plurality of NAVs, only one NAV may be maintained. Refer to FIG. 4. FIG. 4 is a first schematic flowchart of a channel access method in a wireless local area network according to an embodiment of this application. As shown in FIG. 4, the channel access method in the wireless local area network includes but is not limited to the following steps.

S101. A communication device receives a first OBSS frame on a primary channel.

S102. The communication device determines a first channel with a busy channel state based on bandwidth information carried in the first OBSS frame, where any sub-channel of the first channel may not be used together with a second channel, and the second channel is a channel to which the primary channel is switched.

The first OBSS frame may be a frame from a non-own BSS (that is, another cell), and the own BSS herein refers to a cell where the communication device is located.

The primary channel may be a primary 20 MHz channel, a primary 80 MHz channel, or a primary 160 MHz channel. The bandwidth of the primary channel is not limited in some embodiments. The first channel may include one or more sub-channels. A channel bandwidth of each sub-channel is 20 MHz. Any sub-channel of the first channel cannot be used/transmit data together with a temporary primary channel. Optionally, before the first NAV of the primary channel decreases to 0, any sub-channel of the first channel cannot be used together with a temporary primary channel (that is, the second channel in some embodiments) to transmit data. The first channel includes the primary channel.

The second channel may be a temporary primary channel. The temporary primary channel may be negotiated in advance by the communication device before the communication device performs the solution in some embodiments, or may be a secondary channel defined by a standard. A temporary primary channel is usually a specific sub-channel with a bandwidth of 20 MHz, but may also be other bandwidths in a special case. For example, when preamble puncture is not allowed, the bandwidth of the temporary primary channel may also be 80 MHz. At least one station performs listening and packet receiving on the temporary primary channel in this application.

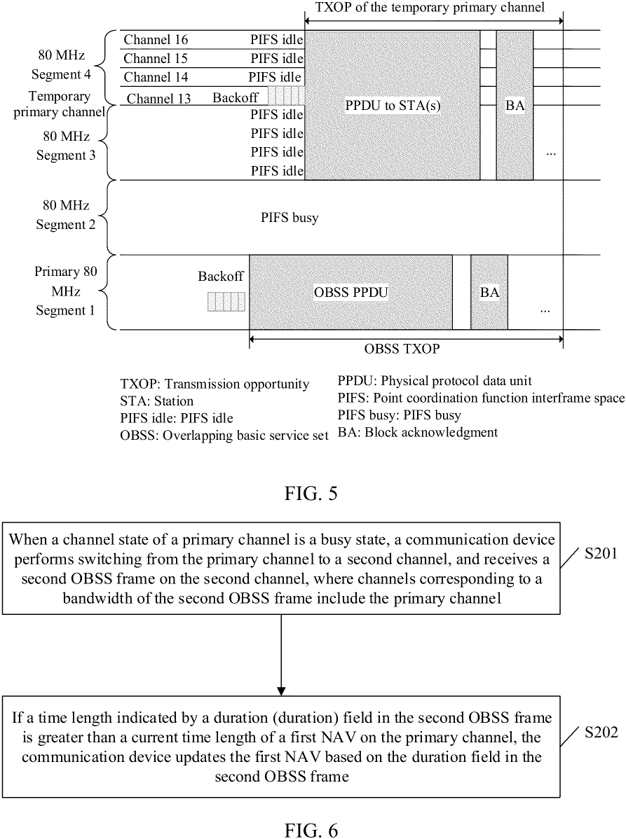

Specifically, after receiving one first OBSS frame on the primary channel, the communication device may perform switching from the primary channel to the temporary primary channel to perform channel contention. Optionally, after receiving the first OBSS frame, the communication device may set/update the first NAV on the primary channel based on a time length indicated by a duration field in the first OBSS frame. The communication device needs to perform switching back to the primary channel before (including time at which the first NAV decreases to 0) the first NAV on the primary channel decreases to 0. For example, refer to FIG. 5. FIG. 5 is a schematic diagram of channel contention on a temporary primary channel according to an embodiment of this application. As shown in FIG. 5, that a primary channel is an 80 MHz channel is taken as an example. A communication device receives one OBSS frame on the primary 80 MHz channel, and sets an NAV. The communication device performs switching from the primary 80 MHz channel to a temporary primary channel to perform channel sensing and backoff. The communication device detects/watches back whether other sub-channels are idle within a point coordination function (PCF) interframe space (PIFS) before the temporary primary channel backs off to 0. When it is detected that a specific sub-channel is idle, the communication device may use the sub-channel to transmit data together with the temporary primary channel. It can be understood that when preamble puncture is allowed, channels used for transmitting data may be discontinuous in frequency domain. When preamble puncture is not allowed, channels used for transmitting data need to be continuous in frequency domain. For example, when the preamble puncture is allowed, assuming that a channel 14 in FIG. 5 is punctured, the communication device may use a temporary primary channel (a channel 13) to transmit data together with a channel 15 and a channel 16. When the preamble puncture is not allowed, the communication device can use only a temporary primary channel (the channel 14) to transmit data.

Therefore, before the communication device performs the switching to the temporary primary channel to start the channel contention, it is further necessary to specify which sub-channels can be used together with a temporary primary channel and which sub-channels are not allowed to be used together with a temporary primary channel. In other words, other sub-channels than the primary 20 MHz channel also need to be specified, which are in the busy state together with the primary 20 MHz channel.

Therefore, when receiving the first OBSS frame on the primary channel, the communication device may record the bandwidth information carried in the first OBSS frame, and determine the first channel with the busy channel state. Optionally, the communication device may perform switching from the primary channel to a second channel (that is, a temporary primary channel) to perform channel contention. After the communication device backs off to 0 on the second channel and before the first NAV decreases to 0, the communication device determines a third channel used for transmitting data, where the third channel does not include any sub-channel of the first channel. In other words, after receiving the first OBSS frame on the primary channel, the communication device records the bandwidth information of the first OBSS frame. In the process of performing the channel contention on the temporary primary channel (or before the first NAV decreases to 0), sub-channels on the bandwidth corresponding to the first NAV cannot be used for data transmission.

The bandwidth information is used for indicating a bandwidth size of the first OBSS frame. The first channel may be a channel that is determined according to a channel plan and corresponds to the bandwidth of the first OBSS frame. For example, channel distribution shown in FIG. 3a is taken as an example. Assuming that the primary channel is a channel 1, and the bandwidth of the first OBSS frame is 80 MHz, the sub-channels corresponding to the bandwidth of the first OBSS frame are the channel 1 to a channel 4 according to a channel distribution principle of FIG. 3a. That is, the first channel includes four sub-channels in total: the channel 1 to the channel 4. For another example, assuming that the primary channel is a channel 5, and the bandwidth of the first OBSS frame is 160 MHz, the sub-channels corresponding to the bandwidth of the first OBSS frame are the channel 1 to the channel 8 according to a channel distribution principle of FIG. 3a. That is, the first channel includes eight sub-channels in total: the channel 1 to the channel 8.

Optionally, if the communication device may maintain two NAVs, for example, an NAV, namely, a basic NAV, of another cell, and an NAV, namely, an intra-BSS NAV, of an own BSS, the first NAV may be a Basic NAV. If the communication device can maintain only one NAV (the NAV is updated when a receiving address of a frame from the own BSS or another cell is not the communication device and a value of a duration field in the frame is greater than a current value of the NAV), the first NAV is the NAV maintained by the communication device.

It can be understood that “data transmission” and “transmitting data” mentioned in this application generally refer to communication. “Data” generally refers to communication information, and is not limited to data information, or may be signaling information or the like. “Transmission” generally refers to sending and receiving.

Optionally, since the 802.11be proposes that 320 MHz channels in a frequency band of 6 GHz may partially overlap, that is, two 320 MHz channels overlap at a 160 MHz channel. Therefore, the bandwidth of the first OBSS frame may be 320 MHz. The first channel may be a 160 MHz channel at which a 320 MHz channel corresponding to the bandwidth of the first OBSS frame and a 320 MHz channel supported by the communication device overlap in frequency. Low 160 MHz/high 160 MHz or a similar indication may be used to distinguish which 320 MHz is currently used. Specifically, when the communication device that supports 320 MHz receives a first OBSS frame of 320 MHz, the communication device may determine whether a 320 MHz channel corresponding to the bandwidth of the first OBSS frame completely overlaps a 320 MHz channel supported by the communication device. If the 320 MHz channel corresponding to the bandwidth of the first OBSS frame completely overlaps the 320 MHz channel supported by the communication device, the 320 MHz channel supported by the communication device cannot be used before the first NAV decreases to 0, that is, the first channel is a complete 320 MHz channel supported by the communication device. In other words, none of the 320 MHz channels supported by the communication device can be used in a contention manner of a temporary primary channel. If the 320 MHz channel corresponding to the first OBSS frame and the 320 MHz channel supported by the communication device overlap only at a 160 MHz channel thereof, the first channel is the overlapped 160 MHz channel. In other words, channel access may still be performed on non-overlapped secondary 160 MHz channels by using the temporary primary channel.

The overlapped channels herein refer to channels that overlap in frequency. For example, a continuous bandwidth of 320 MHz is taken as an example. It is assumed that a 320 MHz channel of a cell/BSS uses 6.0 GHz to 6.32 GHz and that a 320 MHz channel of another cell/BSS uses 6.16 GHz to 6.48 GHz, so 160 MHz channels with frequencies ranging from the 6.16 MHz to the 6.32 GHz overlap.

It can be understood that with development of wireless communication technologies, in a next-generation standard of the 802.11be standard, if a bandwidth greater than 320 MHz is supported, or if more overlapping manners are supported, for example, if overlapping 80 MHz is allowed, the first channel may be correspondingly modified as follows: The first channel is a channel at which the channel corresponding to the bandwidth of the first OBSS frame and a maximum channel supported by the communication device overlap in frequency.

Optionally, if the first OBSS frame received by the communication device is sent in a preamble puncture mode, the first channel may be a channel corresponding to a minimum continuous bandwidth (that is, 80 MHz, 160 MHz, or 320 MHz because the preamble puncture is used only in 80 MHz or a larger bandwidth) occupied by the first OBSS frame. In other words, it is not allowed to initiate contention by using a temporary primary channel within a minimum continuous bandwidth occupied by an OBSS frame. For example, it is assumed that a full bandwidth of the first OBSS frame is 160 MHz, where a first sub-channel and a second sub-channel of high 80 MHz are punctured. In this case, the first channel is a 160 MHz channel corresponding to the 160 MHz.

Or, the first channel may include sub-channels actually occupied by the first OBSS frame. In other words, it is not allowed to initiate contention by using a temporary primary channel on sub-channels actually occupied by an OBSS frame, and contention may be initiated by using a temporary primary channel on all other sub-channels on which no preamble puncture is performed. For example, it is assumed that a full bandwidth of the first OBSS frame is 160 MHz, where a first sub-channel and a second sub-channel of high 80 MHz are punctured. In this case, the first channel includes a third sub-channel and a fourth sub-channel of high 80 MHz in primary 160 MHz, and a low 80 MHz channel.

It can be learned that in some embodiments, when the first OBSS frame is received on the primary channel, the bandwidth information of the first OBSS frame is recorded. The sub-channels occupied by the first OBSS frame are in a busy state. Therefore, after the temporary primary channel backs off to 0, the sub-channels occupied by the first OBSS frame cannot be used as channels used for transmitting data. Atransmission/sending collision on these sub-channels caused by the following can be prevented: using these sub-channels to transmit data together with the temporary primary channel when it is checked/detected that a sub-channel or a plurality of sub-channels occupied by the first OBSS frame are in the idle state within a period of time (such as PIFS) before the temporary primary channel backs off to 0, and a success rate of data transmission can be increased. The channel access on the secondary channel can also be improved.

As an optional embodiment, when other cells protect channels by using RTS/CTS frame interactions before sending the first OBSS frame, if both the RTS frame and the CTS frame can be received by the communication device, the communication device sets/updates the first NAV on the primary channel according to a time length indicated by a duration field in the RTS frame. The communication device will not set/update the first NAV according to the CTS frame, because a duration field in the CTS frame and the duration field in the RTS frame are set to same TXOP end time. Dynamic bandwidth negotiation may be performed in the RTS/CTS frame interaction process. For example, it is indicated in the RTS frame that a bandwidth is 160 MHz. If only a primary 80 MHz channel is available on a sending station side of the CTS frame, the sending station side indicates, in the CTS frame, that a bandwidth is 80 MHz. Afterwards, two communication parties in the TXOP will transmit data by using only a bandwidth not exceeding 80 MHz, that is, a first OBSS frame that is subsequently sent can only be 80 MHz. Therefore, for this case (that is, before sending the first OBSS frame, the other cells protect the channel by using the RTS/CTS frame interaction, and the communication device sets/updates the first NAV on the primary channel according to the RTS frame), if the RTS frame carries the bandwidth information, and the communication device can receive the CTS frame, the communication device may determine the first channel with the busy channel state based on the bandwidth information carried in the CTS frame. In other words, if the RTS frame carries the bandwidth information, and the communication device may receive the CTS frame, the communication device may record the bandwidth of the CTS frame as a bandwidth corresponding to the first NAV. Before (including time at which the first NAV decreases to 0) the first NAV decreases to 0, the first channel is a secondary channel that cannot be used/transmit data together with a temporary primary channel (that is, the second channel in some embodiments).

Optionally, after or at the same time when the communication device determines a first channel with a busy channel state, the communication device may perform switching from the primary channel to the temporary primary channel to perform channel contention. After the communication device backs off to 0 on the second channel (that is, the temporary primary channel) and before (including the time at which the first NAV decreases to 0) the first NAV decreases to 0, the communication device determines a third channel used for transmitting data, where the third channel does not include any sub-channel of the first channel.

It can be learned that in some embodiments, when the RTS/CTS interaction is allowed to protect channels, the first NAV on the primary channel is set/updated based on the RTS frame, and which sub-channels are not allowed to be used/transmit data together with the temporary primary channel before (including the time at which the first NAV decreases to 0) the first NAV decreases to 0 is determined based on the CTS frame. This can prevent the transmission/sending collision on these sub-channels caused by incorrectly detecting that some sub-channels occupied by the first OBSS frame are in the idle state, and the success rate of data transmission can be increased. In addition, the procedure of switching from the primary channel to a secondary channel/a secondary channel for channel access can be optimized.

As another optional embodiment, when the first OBSS frame received by the communication device on the primary channel does not carry the bandwidth information (for example, when the first OBSS frame is sent in a non-high throughput (non-HT) duplicate manner, the bandwidth information may not be carried), the communication device may determine, by using energy detection in the process of receiving the first OBSS frame, which sub-channels have been already used. Therefore, these sub-channels that have been occupied by the first OBSS frame can be avoided when channel contention is initiated on the temporary primary channel. Specifically, when receiving the first OBSS frame on the primary channel, the communication device may perform the energy detection on a plurality of sub-channels in parallel. When an energy detection result on a sub-channel is a busy state, it indicates that the sub-channel is occupied by the first OBSS frame, and the communication device determines that the sub-channel is the first channel. The communication device performs switching from the primary channel to a second channel to perform channel contention. After backing off to 0 on the second channel, the communication device determines a third channel used for transmitting data, where the third channel does not include the first channel. When an energy detection result on a sub-channel is in an idle state, it indicates that the sub-channel is not occupied by the first OBSS frame.

Optionally, an energy detection threshold (or a threshold value) used in the energy detection process may be -62 dBm, or may be a value less than -62 dBm, for example, -82 dBm. In some embodiments, the energy detection threshold in the energy detection process may be set to be less than -62 dBm to improve detection robustness, thereby reducing a failure probability in a data transmission process.

Optionally, in order to protect transmission of an OBSS frame, when the first OBSS frame received by the communication device on the primary channel does not carry the bandwidth information, the switching to the temporary primary channel to perform the channel sensing and backoff may not be allowed.

It can be learned that in some embodiments, when the OBSS frame does not carry the bandwidth information, which sub-channels have been already used is determined by using the energy detection. This can prevent the transmission/sending collision on these sub-channels caused by incorrectly detecting that some sub-channels occupied by the first OBSS frame are in the idle state, and the success rate of data transmission can be increased. In addition, the procedure of switching from the primary channel to a secondary channel/a secondary channel for channel access can be optimized.

In still another optional embodiment, in the foregoing embodiments, it is assumed that after the communication device performs the switching from the primary channel to the temporary primary channel, frame receiving and sending cannot be performed on the primary channel. Some embodiments are specific to a scenario where the communication device has a plurality of transceiver radio frequency channels (one radio frequency channel corresponds to one channel, and it can be understood that the communication device has a plurality of transceiver channels). That is, when performing channel sensing on a primary channel, the communication device may further perform channel sensing on a temporary primary channel. In other words, the communication device may listen on a plurality of channels in parallel. Alternatively, when the primary channel is busy, the communication device may perform channel sensing on a plurality of temporary primary channels simultaneously/in parallel. There are three implementations for the channel access method in some embodiments. The following separately describes the three implementations.

In one implementation, when the communication device performs the listening on the primary channel and the temporary primary channel simultaneously/in parallel, or on the plurality of temporary primary channels simultaneously/in parallel, the communication device may respectively maintain one NAV (for example, Basic NAV) on the primary channel and each temporary primary channel, and may record a bandwidth of a frame for updating the NAV on each channel. After the communication device obtains a TXOP on the primary channel or a temporary primary channel through contention, if the NAV on the primary channel or the NAVs on other temporary primary channels is or are not equal to 0 (that is, greater than 0), it is determined that channels used for transmitting data do not include sub-channels corresponding to bandwidths of frames for updating these NAVs that are not 0. The sub-channels corresponding to the bandwidths may be determined according to a channel plan.

For example, the channel distribution in FIG. 3a is taken as an example. It is assumed that the primary channel is the channel 1, and the temporary primary channels include the channel 5, the channel 9, and the channel 13. It is assumed that the bandwidth of the frame for updating the NAV on the channel 1 is 80 MHz, that the bandwidth of the frame for updating the NAV on the channel 5 is 20 MHz, that the bandwidth of the frame for updating the NAV on the channel 9 is 40 MHz, and that the bandwidth of the frame for updating the NAV on the channel 13 is 80 MHz. It is assumed that the communication device obtains a TXOP through contention on the channel 9, the NAVs on the channel 1 and the channel 5 are not equal to 0, but the NAV on the channel 13 is equal to 0, the channels used for transmitting data do not include: the sub-channels corresponding to the bandwidth of 80 MHz of the frame for updating the NAV on the channel 1, that is, the channel 1 to the channel 4, and the sub-channel corresponding to the bandwidth of 20 MHz of the frame for updating the NAV on the channel 5, that is, the channel 5, but may include the sub-channels corresponding to the bandwidth of 80 MHz of the frame for updating the NAV on the channel 13, that is, the channel 13 to the channel 16.

In another implementation, the primary channel and each temporary primary channel each have an associated sub-channel set. Each associated sub-channel set includes all sub-channels corresponding to a fixed bandwidth, and all the associated sub-channel sets do not overlap with each other. For example, it is assumed that the fixed bandwidth is 80 MHz, and the channel distribution in FIG. 3a is taken as an example. Assuming that the primary channel is the channel 1, the associated sub-channel set of the primary channel includes the channel 1 to the channel 4. Assuming that the temporary primary channels are the channel 5 and the channel 9, the associated sub-channel set of the channel 5 includes the channel 5 to the channel 8, and the associated sub-channel set of the channel 9 includes the channel 9 to the channel 12. The communication device performs the listening on the primary channel and the temporary primary channel simultaneously/in parallel, or on the plurality of temporary primary channels simultaneously/in parallel. After obtaining a TXOP on the primary channel or a temporary primary channel through contention, the communication device may select only the sub-channels in the associated sub-channel sets thereof for transmission. For example, if the communication device obtains the TXOP on the channel 5, the channels used for transmitting data can include only the sub-channels of the channel 5 to the channel 8. In this implementation, a larger small-bandwidth transmission opportunity is obtained by sacrificing a large-bandwidth transmission opportunity, thereby helping to reduce a delay.

It can be learned that in some embodiments, in the scenario where the communication device has a plurality of transceiver radio frequency channels, simultaneously performing the channel contention on the plurality of channels can improve a channel access opportunity and reduce the delay.

In still another implementation, there is one primary 20 MHz channel and one or more temporary primary channels. The primary 20 MHz channel and each temporary primary channel each have one associated sub-channel set. The associated sub-channel set of the primary 20 MHz channel includes a primary 20 MHz channel and all secondary channels, and the associated sub-channel set of each temporary primary channel includes one or more 20 MHz secondary channels. The associated sub-channel set of each temporary primary channel does not overlap with each other.

When the primary 20 MHz channel obtains, at the end of backoff, the TXOP through contention, channels corresponding to a bandwidth of the TXOP may include the primary 20 MHz channel and the plurality of secondary channels. Optionally, the channels corresponding to the bandwidth of the TXOP cannot include the associated sub-channel sets of temporary primary channels with the NAVs that are not equal to 0. When the primary 20 MHz channel is busy because it receives an OBSS frame, temporary primary channels that overlap the channels corresponding to the NAV of the primary 20 MHz channel cannot perform backoff, and temporary primary channels that do not overlap the channels corresponding to the NAV of the primary 20 MHz channel can perform backoff. After a temporary primary channel backs off to 0, only the associated sub-channel set of the temporary primary channel may be selected for transmission. Alternatively, it is selected to wait for other temporary primary channels to continue to perform backoff. After one or more temporary primary channels back off to 0, all the temporary primary channels that back off to 0 and are idle perform sending together by using their associated sub-channel sets. The plurality of temporary primary channels may send one physical layer protocol data unit (PPDU) or a plurality of PPDUs. When a plurality of PPDUs are sent, sending start time and sending end time of the plurality of PPDUs are the same. If a temporary primary channel has backed off to 0, and the channel becomes busy before other temporary primary channels back off to 0, the temporary primary channel needs to reselect a backoff counter (BOC) to continue to perform backoff.

### Embodiment II

Embodiment II of this application describes an impact on an NAV on a primary channel when a bandwidth of a second OBSS frame for setting an NAV on a temporary primary channel covers the primary channel, and further describes which sub-channels that cannot be occupied by sub-channels transmitted by a communication device when the communication device obtains a TXOP on the primary channel after the communication device performs switching back to the primary channel and a second NAV on the temporary primary channel is not 0.

It can be understood that in actual applications, Embodiment II of this application may be implemented together with foregoing Embodiment I, or may be implemented separately. This is not limited in this application.

Refer to FIG. 6. FIG. 6 is a second schematic flowchart of a channel access method in a wireless local area network according to an embodiment of this application. As shown in FIG. 6, the channel access method in the wireless local area network includes but is not limited to the following steps.

S201. When a channel state of a primary channel is a busy state, a communication device performs switching from the primary channel to a second channel, and receives a second OBSS frame on the second channel, where channels corresponding to a bandwidth of the second OBSS frame include the primary channel.

The second channel may be a temporary primary channel. The temporary primary channel may be negotiated in advance by the communication device before the communication device performs the solution in some embodiments, or may be a secondary channel defined by a standard.

Specifically, after the communication device receives the first OBSS frame on the primary channel, it indicates that the channel state of the primary channel is the busy state, and the communication device may perform the switching from the primary channel to the second channel (that is, the temporary primary channel) to perform channel contention/data transmission. Optionally, after receiving the first OBSS frame, the communication device may set/update a first NAV on the primary channel based on a time length indicated by a duration field in the first OBSS frame. After the communication device performs the switching from the primary channel to the temporary primary channel, the communication device receives the second OBSS frame on the second channel (that is, the temporary primary channel), where the channels corresponding to the bandwidth of the second OBSS frame include (or cover) the primary channel. The channels corresponding to the bandwidth of the second OBSS frame are determined according to a channel plan. For example, the channel distribution in FIG. 3a is taken as an example. Assuming that the primary channel is the channel 1, that the temporary primary channel is the channel 5, and that the bandwidth of the second OBSS frame is 160 MHz, the channels corresponding to the bandwidth of 160 MHz of the second OBSS frame are primary 160 MHz channels (including eight sub-channels from the channel 1 to the channel 8 in total).

After receiving the second OBSS frame on the second channel, the communication device may set a second NAV on the second channel based on a duration field in the second OBSS frame.

Neither the first OBSS frame nor the second OBSS frame is a frame of an own BSS. The own BSS herein refers to a cell where the communication device is located. The first NAV may be a Basic NAV or an NAV on the primary channel, and the second NAV may be a Basic NAV or an NAV on the temporary primary channel. The primary channel may be a primary 20 MHz channel, a primary 80 MHz channel, or a primary 160 MHz channel. The bandwidth of the primary channel is not limited in some embodiments.

S202. If the time length indicated by the duration field in the second OBSS frame is greater than a current time length of the first NAV on the primary channel, the communication device updates the first NAV based on the duration field in the second OBSS frame.

Specifically, since the channels corresponding to the bandwidth of the second OBSS frame cover the primary channel, the communication device should also be able to receive the second OBSS frame on the primary channel. Therefore, if the time length indicated by the duration field in the second OBSS frame is greater than the current time length of the first NAV on the primary channel (or a current value of the first NAV), the communication device may update the first NAV based on the duration field in the second OBSS frame. For example, if the time length indicated by the duration field in the second OBSS frame is 4 ms, and the current value of the first NAV is 1 ms, the value of the first NAV may be updated to 4 ms.

Optionally, the communication device needs to perform switching back to the primary channel before (including time at which the first NAV decreases to 0) the first NAV on the primary channel decreases to 0.

Optionally, if the communication device has negotiated only one temporary primary channel (that is, the second channel) in advance before performing the solution in some embodiments, or only one temporary primary channel (that is, the second channel) is defined in a standard, when the time length indicated by the duration field in the second OBSS frame is greater than or equal to the current time length of the first NAV, the communication device may perform switching from the second channel back to the primary channel to perform channel contention. The communication device needs to perform the switching back to the primary channel before the first NAV on the primary channel decreases to 0.

Optionally, if the communication device has negotiated a plurality of temporary primary channels (the plurality in this application refers to being greater than or equal to two) in advance before performing the solution in some embodiments, or a plurality of temporary primary channels are defined in a standard, when the time length indicated by the duration field in the second OBSS frame is greater than or equal to the current time length of the first NAV, the communication device may perform switching from the second channel back to the primary channel to perform channel contention or to a fourth channel to perform channel contention. The second channel may be any one of the plurality of temporary primary channels, and the fourth channel may be a temporary primary channel, different from the second channel, among the plurality of temporary primary channels.

It can be understood that when the time length indicated by the duration field in the second OBSS frame is greater than the current time length of the first NAV, an execution order of the switching performed by the communication device from the second channel back to the primary channel to perform the channel contention or to the fourth channel to perform the channel contention and the updating the first NAV based on the duration field in the second OBSS frame is not limited. The operations may be performed in sequence, in a reverse order, or in parallel/simultaneously.

It can be learned that in some embodiments, when channel busy time on a temporary primary channel (that is, the second channel) is greater than channel busy time on the primary channel, the temporary primary channel is switched back to the primary channel or to another temporary primary channel (that is, the fourth channel) to perform channel sensing and backoff. In this way, long-time waiting on the second channel can be avoided, a channel access opportunity can be improved, and a delay can be reduced.

As an optional embodiment, after the communication device performs switching from the second channel to the primary channel back to perform channel contention, if a value of the second NAV on the second channel is greater than zero when the communication device obtains a TXOP on the primary channel, the communication device determines that channels used for transmitting data do not include any sub-channel of the channels corresponding to the bandwidth of the second OBSS frame. In other words, the transmission sub-channels selected by the communication device should not include the sub-channels corresponding to the second NAV. If the value of the second NAV on the second channel is equal to zero when or before the communication device obtains the TXOP on the primary channel, the communication device determines that the channels used for transmitting data may include the channels corresponding to the bandwidth of the second OBSS frame. In other words, the transmission sub-channels selected by the communication device may include the sub-channels corresponding to the second NAV. It can be understood that the channels used for transmitting data herein need to include the primary channel. It can be understood that the channels corresponding to the bandwidth of the second OBSS frame do not include the primary channel. If the channels corresponding to the bandwidth of the second OBSS frame include the primary channel, it is impossible that the second NAV is not 0 when the communication device obtains the TXOP on the primary channel.

It can be learned that in some embodiments, when the TXOP is obtained on the primary channel, the second NAV on the temporary primary channel is not 0. This indicates that the temporary primary channel is still occupied by the second OBSS frame. Therefore, the channels used for transmitting data may not include the channel occupied by the second OBSS frame, thereby avoiding a collision during transmission and increasing a transmission success rate.

Optionally, after the communication device performs the switching from the second channel to the fourth channel to perform the channel contention, if the second NAV on the second channel is not equal to 0 (that is, greater than 0) when the communication device obtains the TXOP on the fourth channel, the communication device determines that the channels used for transmitting data do not include any sub-channel of the channels corresponding to the bandwidth of the second OBSS frame or any sub-channel of the channels corresponding to the bandwidth of the first OBSS frame. If the second NAV on the second channel is not equal to 0 (that is, greater than 0) when the communication device obtains the TXOP on the fourth channel, the communication device determines that the channels used for transmitting data do not include any sub-channel of the channels corresponding to the bandwidth of the first OBSS frame, but may include the channels corresponding to the bandwidth of the second OBSS frame. After the communication device obtains the TXOP on the fourth channel, end time of the TXOP on the fourth channel may not exceed end time of a TXOP on the primary channel. The communication device needs to perform the switching back to the primary channel before the first NAV on the primary channel decreases to 0. It can be understood that the channels used for transmitting data herein need to include the fourth channel.

It can be learned that in some embodiments when a TXOP is obtained on a temporary primary channel, neither a NAV on another temporary primary channel nor the NAV on the primary channel is 0. This indicates that the another temporary primary channel is still occupied by the second OBSS frame, and the primary channel is still occupied by the first OBSS frame. Therefore, the channels used for transmitting data may not include the channels occupied by the OBSS frames, thereby avoiding a collision during transmission and increasing a transmission success rate.

Optionally, if the communication device has not obtained a TXOP on the fourth channel through contention after the NAV on the second channel decreases to 0, the communication device may continue to perform channel contention on the fourth channel, or may perform switching from the fourth channel back to the second channel to perform channel sensing and backoff.

It can be learned that in some embodiments, when a bandwidth of a frame (that is, the second OBSS frame) for setting the second NAV set on the temporary primary channel (that is, the second channel) covers the primary channel, the first NAV on the primary channel is updated. When the communication device performs switching back to the primary channel, but the second NAV on the temporary primary channel (that is, the second channel) is not zero, the communication device may not occupy, during obtaining the TXOP on the primary channel, the temporary primary channel (that is, the second channel) and the sub-channels corresponding to the bandwidth of the second OBSS frame. The procedure of switching from the primary channel to the secondary channel to perform channel access can be further optimized; a collision during transmission can also be avoided; and a transmission success rate can be increased.

As an optional embodiment, there are a plurality of temporary primary channels in some embodiments. After setting/updating the second NAV on the second channel based on the duration field in the second OBSS frame, the communication device may perform switching from the second channel to the fourth channel to perform channel contention. The second channel may be any one of the plurality of temporary primary channels, and the fourth channel may be a temporary primary channel, different from the second channel, among the plurality of temporary primary channels. If the second NAV on the second channel is not equal to 0 (that is, greater than 0) when the communication device obtains the TXOP on the fourth channel, the communication device determines that the channels used for transmitting data do not include any sub-channel of the channels corresponding to the bandwidth of the second OBSS frame and any sub-channel of the channels corresponding to the bandwidth of the first OBSS frame. If the second NAV on the second channel is not equal to 0 (that is, greater than 0) when the communication device obtains the TXOP on the fourth channel, the communication device determines that the channels used for transmitting data do not include any sub-channel of the channels corresponding to the bandwidth of the first OBSS frame, but may include the channels corresponding to the bandwidth of the second OBSS frame. After the communication device obtains the TXOP on the fourth channel, end time of the TXOP on the fourth channel does not exceed end time of a TXOP on the primary channel. The communication device needs to perform the switching back to the primary channel before the first NAV on the primary channel decreases to 0. It can be understood that the channels used for transmitting data herein need to include the fourth channel.

Optionally, if the time length indicated by the duration field in the second OBSS frame is greater than the current time length of the first NAV on the primary channel (or a current value of the first NAV), the communication device may update the first NAV based on the duration field in the second OBSS frame.

It can be learned that in some embodiments, after the second NAV on a temporary primary channel (that is, the second channel) is set/updated, the communication device performs switching from the temporary primary channel to another temporary primary channel to perform channel contention. It is not necessary to determine, according to holding time on the temporary primary channel, whether to switch to the another temporary primary channel, and it is only necessary to determine that the temporary primary channel needs to wait (that is, after the second NAV on the temporary primary channel is set/updated) for switching, which can further improve a channel access opportunity and reduce a delay.

### Embodiment III

Embodiment III of this application describes how to generate and maintain values of a contention window and a backoff counter on a temporary primary channel in a process of switching from a primary channel to the temporary primary channel to perform channel contention.

It can be understood that in actual applications, Embodiment III of this application may be implemented together with any one or more of Embodiment I and Embodiment II. For example, Embodiment III of this application is implemented together with Embodiment I or Embodiment II, or Embodiment III of this application is implemented together with Embodiment I and Embodiment II. Alternatively, Embodiment II of this application may be implemented separately. This is not limited in this application.

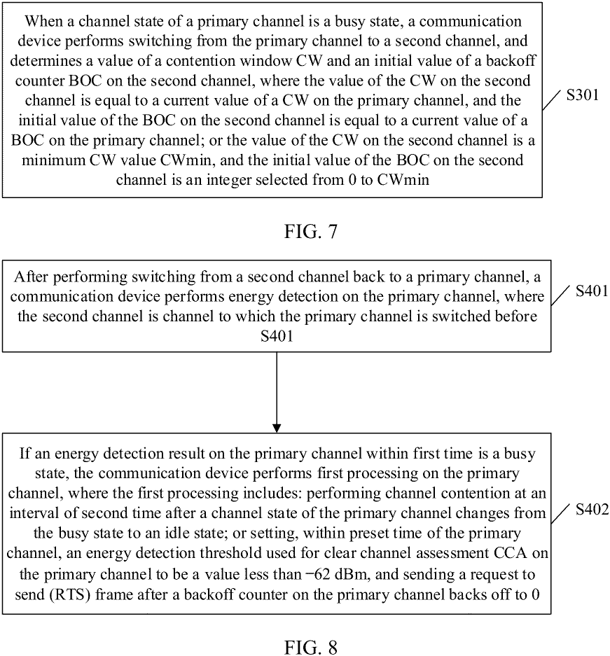

Refer to FIG. 7. FIG. 7 is a third schematic flowchart of a channel access method in a wireless local area network according to an embodiment of this application. As shown in FIG. 7, the channel access method in the wireless local area network includes but is not limited to the following steps.

S301. When a channel state of a primary channel is a busy state, a communication device performs switching from the primary channel to a second channel, and determines a value of a contention window (CW) and an initial value of a BOC on the second channel, where the value of the CW on the second channel is equal to a current value of a CW on the primary channel, and the initial value of the BOC on the second channel is equal to a current value of a BOC on the primary channel; or the value of the CW on the second channel is a minimum CW value CWmin, and the initial value of the BOC on the second channel is an integer selected from 0 to CWmin.

The second channel may be a temporary primary channel. The temporary primary channel may be negotiated in advance by the communication device before the communication device performs the solution in some embodiments, or may be a secondary channel defined by a standard. The primary channel may be a primary 20 MHz channel, a primary 80 MHz channel, or a primary 160 MHz channel. The bandwidth of the primary channel is not limited in some embodiments.

Specifically, after the communication device receives the first OBSS frame on the primary channel, it indicates that the channel state of the primary channel is the busy state, and the communication device may perform the switching from the primary channel to the second channel (that is, the temporary primary channel) to perform channel contention. Optionally, the communication device may set/update a first NAV on the primary channel based on a time length indicated by a duration field in the received first OBSS frame. Alternatively, when a result of energy detection performed by the communication device on the primary channel is a busy state, the communication device may perform switching from the primary channel to a second channel (that is, a temporary primary channel) to perform channel contention. The communication device needs to perform switching back to the primary channel before or when the first NAV on the primary channel decreases to 0.

Since an NAV is set on the primary channel or due to the busy state on the primary channel, the switching to the temporary primary channel to perform channel sensing and backoff indicates a temporary or opportunistic action, and switching back to the primary channel to perform channel contention will be performed within extremely short time (which generally does not exceed end time of the NAV on the primary channel). Therefore, in order to ensure fairness of contention on the primary channel, the values of the CW and the BOC on the primary channel should remain unchanged after the switching to the temporary primary channel to perform the channel contention. That is, a new set of CW and BOC needs to be added to the temporary primary channel, namely, the channel sensing and the backoff are respectively performed on the primary channel and the temporary primary channel. The channel sensing and backoff processes on the primary channel and the temporary primary channel do not affect each other, and may be performed independently.

It can also be understood that in an enhanced distributed channel access (EDCA) mechanism or a CSMA/CA (carrier sense multiple access with collision avoid) mechanism, since the NAV is set on the primary channel at this time, it indicates that the primary channel is in a busy state. Therefore, the BOC on the primary channel will not decrease in a time period indicated by the NAV, and the CW on the primary channel will not change in the time period indicated by the NAV, either. It can be further understood that in the EDCA mechanism or the CSMA/CA mechanism, the value of the CW changes only when the channel contention succeeds, the channel contention fails, or the channel contention is performed again. The CW will not change in one backoff process.

Therefore, when the channel contention is performed on the second channel, the value of the CW and the initial value of the BOC on the second channel need to be determined. Therefore, in the process of the switching from the primary channel to the second channel (that is, the temporary primary channel) to perform the channel contention, the communication device may determine the value of the CW and the initial value of the BOC on the second channel. In an implementation, the communication device may set the value of the CW on the second channel to be a minimum CW value, that is, CWmin. CWmin may be a parameter that is used for CW initialization and that is broadcast by an AP in a beacon frame, and CWmin is a minimum value that can be selected by the CW. An integer is selected from a range [0, CWmin] in a uniform and random manner as the initial value of the backoff counter. This implementation is also a manner of initializing the CW and the BOC on the primary channel, or generating the CW and the BOC after a frame is successfully transmitted.

In another implementation, the communication device may set the value of the CW on the second channel to be the current value of the CW on the primary channel, and may set the initial value of the BOC on the second channel to be the current value of the BOC on the primary channel. For example, the initial value of the BOC on the primary channel is 8 (in timeslot, that is, timeslot). When the BOC decreases to 6 as time decreases, the communication device performs channel contention when switching from the primary channel to the second channel, and the initial value of the BOC on the second channel is 6. It can be understood that this implementation is equivalent to reflecting a transmission state on the primary channel to the temporary primary channel, because the CW and the BOC on the primary channel are determined by the transmission state on the primary channel.

Optionally, when the communication device performs switching from the second channel to a fourth channel to perform channel contention, in a process of performing the channel contention on the fourth channel by the communication device, the communication device may set a value of a CW on the fourth channel to be the current value of the CW on the second channel or the primary channel, and set an initial value of a BOC on the fourth channel to be the current value of the BOC on the second channel or the primary channel. The second channel may be any one of the plurality of temporary primary channels, and the fourth channel may be a temporary primary channel, different from the second channel, among the plurality of temporary primary channels.

Optionally, after the communication device performs the switching from the second channel (that is, the temporary primary channel) back to the primary channel to perform channel contention, if an NAV is set on the primary channel again, the communication device may perform switching to the second channel (that is, the temporary primary channel) again to perform listening or backoff. In the process of performing the listening or backoff on the second channel by the communication device again, the communication device may determine the value of the CW and the initial value of the BOC on the second channel. In an implementation, the same CW and BOC determining manner is used at each time of the switching to the temporary primary channel, that is, the value of the CW on the second channel is set to be CWmin, and an integer is randomly selected from the range [0, CWmin] as the initial value of the BOC. Alternatively, the current value of the CW and the current value of the BOC on the primary channel are set to be the value of the CW and the initial value of the BOC on the temporary primary channel. In another implementation, the communication device may record the CW and the BOC on the temporary primary channel during the last switching from the temporary primary channel back to the primary channel. In the process of the switching to the temporary primary channel again to perform channel contention, the values of the CW and the BOC that are recorded last time are still used.

It can be learned that in some embodiments, the manner of determining the CW and the BOC on the temporary primary channel in the process of performing the channel contention on the temporary primary channel can improve a channel access flow on the secondary channel.

### Embodiment IV

Embodiment IV of this application describes how to perform channel contention on a primary channel if a channel state of the primary channel is a busy state after a communication device performs switching from a temporary primary channel back to the primary channel, and further describes how to perform channel contention on the primary channel when time at which the communication device performs switching back to the primary channel is later than time at which an NAV on the primary channel decreases to 0.

It can be understood that in actual applications, Embodiment IV of this application may be implemented together with any one or several of foregoing Embodiment I to Embodiment III, or may be implemented separately. This is not limited in this application.

Refer to FIG. 8. FIG. 8 is a fourth schematic flowchart of a channel access method in a wireless local area network according to an embodiment of this application. As shown in FIG. 8, the channel access method in the wireless local area network includes but is not limited to the following steps.

S401. After performing switching from a second channel back to a primary channel, a communication device performs energy detection on the primary channel, where the second channel is a channel to which the primary channel is switched before S401.

S402. If an energy detection result on the primary channel within a first time is a busy state, the communication device performs first processing on the primary channel, where the first processing includes: performing channel contention at an interval of a second time after the channel state of the primary channel changes from the busy state to an idle state; or setting, within a preset time of the primary channel, an energy detection threshold used for CCA on the primary channel to be a value less than -62 dBm, and sending a RTS frame after a BOC on the primary channel backs off to 0.

The second channel may be a temporary primary channel. The temporary primary channel may be negotiated in advance by the communication device before the communication device performs the solution in some embodiments, or may be a secondary channel defined by a standard. The primary channel may be a primary 20 MHz channel, a primary 80 MHz channel, or a primary 160 MHz channel. The bandwidth of the primary channel is not limited in some embodiments.

Specifically, after the communication device receives the first OBSS frame on the primary channel, it indicates that the channel state of the primary channel is the busy state, and the communication device may perform the switching from the primary channel to the second channel (that is, the temporary primary channel) to perform channel contention. Optionally, the communication device may set/update a first NAV on the primary channel based on a time length indicated by a duration field in the received first OBSS frame.

In order to ensure fairness of contention between stations on the primary channel and stations in other cells, the communication device should perform switching back to the primary channel before a first NAV on the primary channel decreases to 0 (or before a TXOP on the primary channel ends). The channel state of the primary channel needs to be detected within a period of time after the switching back to the primary channel, so as to determine how to perform channel contention subsequently. That is, the communication device performs the energy detection on the primary channel after performing the switching from the second channel back to the primary channel. In the energy detection process for the primary channel, if energy on the primary channel is less than the energy detection threshold, it indicates that the primary channel is in the idle state or the energy detection result on the primary channel is the idle state. If the energy on the primary channel is greater than or equal to the energy detection threshold, it indicates that the primary channel is in the busy state or the energy detection result on the primary channel is the busy state. The energy detection threshold may be -62 dBm, which is an energy detection threshold used for normal CCA. Alternatively, the energy detection threshold may be less than -62 dBm, for example, -82 dBm. Transmission of an OBSS frame is protected by further reducing the energy detection threshold.

If the energy detection result on the primary channel within the first time is the idle state, the communication device may perform EDCA contention on the primary channel. If the energy detection result on the primary channel within the first time is the busy state, the communication device may perform the first processing on the primary channel to protect an OBSS frame that may be being transmitted. In other words, if the channel is idle within a period of time after the switching back to the primary channel, common EDCA contention may be performed. If the channel is busy within the period of time after the switching back to the primary channel, some special processing needs to be performed to protect an OBSS frame that may be being transmitted.

The first processing may include any one of the following implementations: (1) after the channel state of the primary channel changes from the busy state to the idle state, performing channel contention on the primary channel after the interval of a second time. (The channel contention here is the common EDCA). (2) Within time counted by a first timer of the primary channel, setting the energy detection threshold used for the CCA on the primary channel to be the value less than -62 dBm (for example, -82 dBm), and sending the RTS frame after the backoff counter on the primary channel backs off to 0, so as to perform channel protection. The second time may be an extended interframe space (EIFS). The first timer may start timing at the switching back to the primary channel. Optionally, a length of the first timer is a medium sync delay (e.g., MediumSyncDelay) or an NAV sync delay (e.g., NAVSyncDelay) time, which is usually a time length obtained by a maximum PPDU time length plus a short interframe space (SIFS) and a time length of a block acknowledgment (BA) frame, or a TXOP limit time length. Time counted by the first timer is the foregoing preset time.

Optionally, the foregoing first time may start at the time when the communication device performs switching from the second channel back to the primary channel until the end of the PIFS when the first NAV on the primary channel decreases to 0. In other words, if the energy detection result on the primary channel after the switching back to the primary channel is busy, and the primary channel keeps busy within the PIFS time after the first NAV on the primary channel decreases to 0, the first processing is performed on the primary channel.

Optionally, after the switching back to the primary channel, if the energy detection result on the primary channel is the busy state within the PIFS time after the first NAV on the primary channel decreases to 0, the first processing is performed on the primary channel.

Optionally, if the energy detection result on the primary channel is the busy state within the PIFS time after the switching back to the primary channel, the first processing is performed on the primary channel.

It can be understood that some embodiments is applicable to a scenario where no packet header is detected on the primary channel within a period of time. If the communication device detects a packet header within the time period, the communication device will continue to parse the packet, and further sets an NAV on the primary channel. In this case, the first processing is not performed on the primary channel.

Optionally, although the communication device should perform the switching back to the primary channel before the first NAV on the primary channel decreases to 0, there are some special requirements that make the time at which the communication device performs the switching from the second channel back to the primary channel later than the time at which the first NAV on the primary channel changes to 0. In other words, due to some special requirements, the time at which the communication device performs the switching back to the primary channel may be later than the time at which the NAV on the primary channel decreases to 0. For example, the communication device obtains a TXOP on the temporary primary channel, and data being transmitted is low-delay data and needs to be sent as soon as possible. In this case, if the communication device performs the switching back to the primary channel to perform the channel contention, a delay will be increased. Therefore, when the communication device completes sending the low-delay data on the temporary primary channel and performs the switching back to the primary channel, the first NAV on the primary channel may possibly have decreased to 0. When the time at which the communication device performs switching from the second channel back to the primary channel is later than the time at which the first NAV on the primary channel becomes 0, the communication device sets, within the time counted by the first timer of the primary channel, the energy detection threshold used for CCA on the primary channel to be less than -62 dBm (for example, -82 dBm), and sends the RTS frame after the backoff counter on the primary channel backs off to 0, so as to perform channel protection.

It can be learned that in some embodiments, when the channel state of the primary channel is the busy state after the switching back to the primary channel or the time of the switching back to the primary channel is later than the time at which the NAV on the primary channel decreases to 0, the energy detection threshold used for the CCA on the primary channel is reduced, and the RTS frame is sent, after the backoff counter backs off to 0 on the primary channel, to perform the channel protection, so that an OBSS frame that may be being transmitted on the primary channel can be protected, a collision probability can be reduced, and a channel access flow on the primary channel in different cases can be improved.

In an example, a data stream implemented with reference to Embodiment I to Embodiment IV includes: 1) when an AP receives an OBSS frame (denoted as a first OBSS frame) on a primary channel and sets a Basic NAV according to the first OBSS frame, the AP records a bandwidth of the first OBSS frame, and then performs switching to a temporary primary channel to perform channel contention. (2) The AP receives an OBSS frame (denoted as a second OBSS frame) on the temporary primary channel, where a bandwidth of the second OBSS frame covers the primary channel, and a value of a duration field of the second OBSS frame is greater than a current NAV value on the primary channel. The AP updates the NAV on the primary channel according to the second OBSS frame. (3) In the process of performing the channel contention on the temporary primary channel, the AP sets a value of a CW on the temporary primary channel according to CWmin or a current value of a CW on the primary channel. (4) After the AP obtains a TXOP on the temporary primary channel, channels selected by the AP for transmitting data may not include sub-channels corresponding to the NAV of the primary channel. (5) After the AP performs switching back to the primary channel, if a channel state of the primary channel is a busy state, after the channel state of the primary channel becomes an idle state, common EDCA contention needs to be performed after an EIFS. Alternatively, a blind recovery process is implemented, that is, within time counted by a first timer of the primary channel, an energy detection threshold used for CCA on the primary channel is set to be -82 dBm, and an RTS frame is sent after a backoff counter on the primary channel backs off to 0, so as to perform channel protection.

### Embodiment V

Embodiment V of this application describes how a communication device determines when to perform switching back to a primary channel if busyness on the primary channel is caused only by energy detection of CCA.

It can be understood that in actual applications, Embodiment V of this application may be implemented together with foregoing Embodiment III, or may be implemented separately. This is not limited in this application.

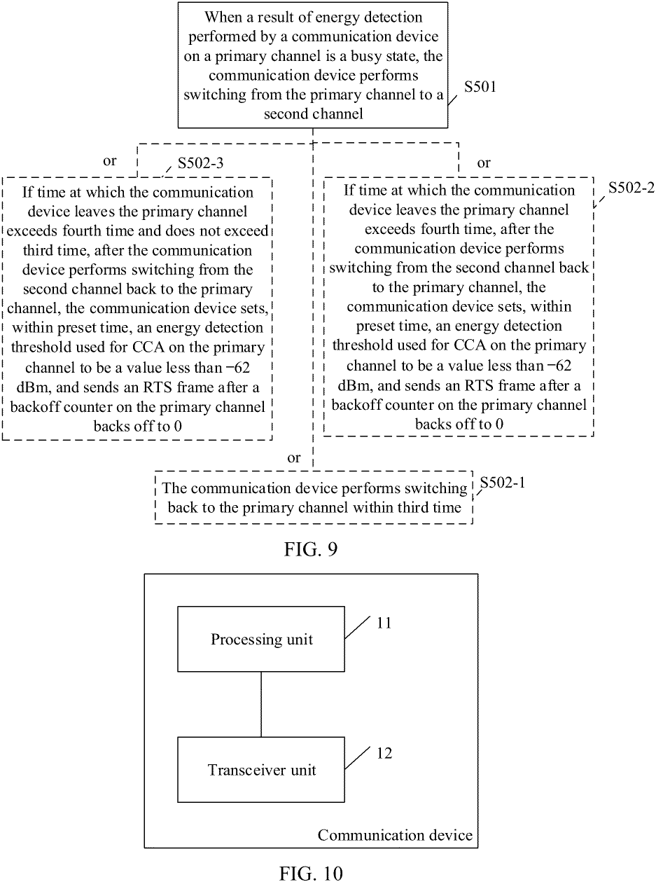

Refer to FIG. 9. FIG. 9 is a fifth schematic flowchart of a channel access method in a wireless local area network according to an embodiment of this application. As shown in FIG. 9, the channel access method in the wireless local area network includes but is not limited to the following steps.

S501. When a result of energy detection performed by a communication device on a primary channel is in a busy state, the communication device performs switching from the primary channel to a second channel.

S502-1. The communication device performs switching back to the primary channel within a third time.

S502-2. If time at which the communication device leaves the primary channel exceeds a fourth time, after the communication device performs switching from the second channel back to the primary channel, the communication device sets, within preset time, an energy detection threshold used for CCA on the primary channel to be a value less than -62 dBm, and sends an RTS frame after a backoff counter on the primary channel backs off to 0.

S502-3. If time at which the communication device leaves the primary channel exceeds a fourth time and does not exceed a third time, after the communication device performs switching from the second channel back to the primary channel, the communication device sets, within a preset time, an energy detection threshold used for CCA on the primary channel to be a value less than -62 dBm, and sends an RTS frame after a backoff counter on the primary channel backs off to 0.

The second channel may be a temporary primary channel. The temporary primary channel may be negotiated in advance by the communication device before the communication device performs the solution in some embodiments, or may be a secondary channel defined by a standard. The primary channel may be a primary 20 MHz channel, a primary 80 MHz channel, or a primary 160 MHz channel. The bandwidth of the primary channel is not limited in some embodiments.

When the busy state on the primary channel is caused only by the energy detection (that is, the energy detection result on the primary channel is the busy state), if a value of the first NAV on the primary channel is 0, the rule of switching from the temporary primary channel back to the primary channel no later than the time before the first NAV on the primary channel decreases to 0 cannot be followed. Therefore, in this case, if the communication device further intends to perform switching to the temporary primary channel to perform channel sensing and backoff, for example, if the communication device intends to perform switching to the temporary primary channel to send low-delay data, some new conditions need to be introduced to restrict the channel sensing and backoff on the temporary primary channel.

Specifically, the communication device performs the energy detection on the primary channel. If the energy detection result on the primary channel is the busy state, the communication device may perform switching from the primary channel to the second channel (that is, the temporary primary channel). The communication device needs to restrict the time for leaving the primary channel, so that the communication device may perform switching back to the primary channel in relatively short time to perform channel contention.

In a first implementation, the restriction is performed by using longest leave time. Specifically, the time at which the communication device leaves the primary channel does not exceed the third time. The time at which the communication device leaves the primary channel starts from the time at which the communication device leaves the primary channel and ends at the time at which the communication device performs switching back to the primary channel. In other words, the time at which the communication device leaves the primary channel is calculated from the time at which the communication device leaves the primary channel to the time at which the communication device performs switching back to the primary channel. It can be understood that in a case where a switching delay between the primary channel and the temporary primary channel is not ignored, the time at which the communication device leaves the primary channel includes the switching delay. Generally, the switching delay of the communication device between the primary channel and the temporary primary channel may be ignored, that is, the time at which the communication device leaves the primary channel may also be calculated from the time of switching to the temporary primary channel to the time of switching back to the primary channel.

The third time does not exceed a limit time length of the TXOP limit, that is, TXOP limit, or does not exceed a length of a maximum PPDU specified in a standard. The third time may be specified by using a standard protocol, or may be obtained by performing broadcasting in a management frame such as a beacon frame by the AP.

In a second implementation, the longest time at which the communication device leaves the primary channel is not limited, and is restricted by using suggested leave time. Specifically, if the time at which the communication device leaves the primary channel exceeds a fourth time, after the communication device performs switching from the second channel back to the primary channel, the communication device sets, within the time counted by the first timer of the primary channel, an energy detection threshold used for CCA on the primary channel to be a value less than -62 dBm (for example, -82 dBm), and sends an RTS frame after a BOC on the primary channel backs off to 0, so as to perform channel protection. If the time at which the communication device leaves the primary channel does not exceed the fourth time, the communication device performs EDCA on the primary channel after performing the switching from the second channel back to the primary channel. In other words, if the time at which the communication device leaves the primary channel does not exceed the fourth time, the communication device may use common EDCA contention after performing the switching back to the primary channel. If the time at which the communication device leaves the primary channel exceeds the fourth time, when the communication device performs the switching back to the primary channel, blind recovery needs to be performed, that is, the energy detection threshold needs to be reduced within time of a medium sync delay (e.g., MediumSyncDelay) timer (that is, the first timer) to perform EDCA contention. The time counted by the first timer is the preset time.

Optionally, the fourth time includes four parts: channel contention time, short frame transmission time, an SIFS, and acknowledgment frame transmission time. The channel contention time is not a definite time length. On the one hand, the temporary primary channel will wait when it is busy. On the other hand, the BOC is randomly selected. CWmin=7 and BOC=CWmin are taken as an example for calculation. In this case, the channel contention time length is 34 µs (distributed inter-frame space, distributed inter-frame spacing, DIFS) + 7*9 µs (a time length of one timeslot is 9 µs) = 97 µs. It is assumed that a packet length of a short packet is 64 bytes, and a MAC packet header and a frame check sequence (FCS) are about 100 bytes. Transmission of the entire short packet probably takes 150 µs by considering a physical layer packet header. The SIFS is 16 µs. The shortest acknowledgment frame transmission time is 48 µs. The fourth time may be obtained by adding the four parts of time, that is, 311 µs. Since there are many uncertain factors, the fourth time is about hundreds of microseconds, and a specific length of the fourth time is usually specified in a standard.

The time at which the communication device leaves the primary channel starts from the time at which the communication device leaves the primary channel and ends at the time at which the communication device performs switching back to the primary channel. When the switching delay between the primary channel and the temporary primary channel is ignored, the time at which the communication device leaves the primary channel does not include the switching delay. That is, the time at which the communication device leaves the primary channel is calculated from the time of switching to the temporary primary channel to the time of switching back to the primary channel.

In a third implementation, restriction is performed by using the longest leave time and suggested leave time. That is, the third implementation may be understood as a combination of the first implementation and the second implementation. The time at which the communication device leaves the primary channel may not exceed a third time. If the time at which the communication device leaves the primary channel does not exceed a fourth time, the communication device performs EDCA on the primary channel after performing the switching from the second channel back to the primary channel. If the time at which the communication device leaves the primary channel exceeds the fourth time and does not exceed the third time, after the communication device performs switching from the second channel back to the primary channel, the communication device sets, within the time counted by the first timer of the primary channel, an energy detection threshold used for CCA on the primary channel to be a value less than -62 dBm (for example, -82 dBm), and sends an RTS frame after the backoff counter on the primary channel backs off to 0, so as to perform channel protection. In other words, if the time at which the communication device leaves the primary channel does not exceed the fourth time, the communication device may use common EDCA contention after performing the switching back to the primary channel. When the time at which the communication device leaves the primary channel exceeds the fourth time, but does not exceed the third time, when the communication device performs the switching back to the primary channel, blind recovery needs to be performed, that is, the energy detection threshold needs to be reduced within time of a medium sync delay (e.g., MediumSyncDelay) timer (that is, the first timer) to perform EDCA contention. The third time is greater than the fourth time. The time counted by the first timer is the preset time.

The time at which the communication device leaves the primary channel starts from the time at which the communication device leaves the primary channel and ends at the time at which the communication device performs switching back to the primary channel. When the switching delay between the primary channel and the temporary primary channel is ignored, the time of stay after the communication device performs the switching to the temporary primary channel does not include the switching delay. That is, the time at which the communication device leaves the primary channel is calculated from the time of switching to the temporary primary channel to the time of switching back to the primary channel.

Optionally, in the energy detection process for the primary channel, if energy on the primary channel is less than the energy detection threshold, it indicates that the primary channel is in the idle state or the energy detection result on the primary channel is the idle state. If the energy on the primary channel is greater than or equal to the energy detection threshold, it indicates that the primary channel is in the busy state or the energy detection result on the primary channel is the busy state. The energy detection threshold may be -62 dBm, which is an energy detection threshold used for normal CCA. Alternatively, the energy detection threshold may be less than -62 dBm, for example, -82 dBm. Transmission of an OBSS frame is protected by further reducing the energy detection threshold.

Optionally, if the energy detection result on the primary channel is an idle state, the communication device may perform data transmission by using the primary channel.

It can be understood that some embodiments are applicable to a scenario where no packet header is detected on the primary channel within a period of time. Therefore, the energy detection result on the primary channel may reflect whether the primary channel is idle.

It can be learned that, in some embodiments, when it is detected that the primary channel is busy through energy detection, the temporary primary channel may also be switched to perform channel contention, to improve a channel access opportunity. In addition, a time of leaving the primary channel is restricted, so that the communication device can switch back to the primary channel in a relatively short time to perform channel contention, and a channel access procedure of switching from the primary channel to the secondary channel can be optimized.

The foregoing content describes in detail the methods provided in this application. To better implement the foregoing solutions in embodiments of this application, embodiments of this application further provide corresponding apparatuses or devices.

In embodiments of this application, the communication device may be divided into function modules based on the foregoing method examples. For example, each function module may be obtained through division based on a corresponding function, or two or more functions may be integrated into one processing module. The integrated module may be implemented in a form of hardware, or may be implemented in a form of a software functional module. It should be noted that in some embodiments, division into the modules is an example and is merely logical function division, and may be other division in an actual implementation.

When an integrated unit is adopted, refer to FIG. 10. FIG. 10 is a schematic diagram depicting a structure of a communication device provided according to an embodiment of this application. As shown in FIG. 10, the communication device includes a processing unit 11 (e.g., a processing circuit) and a transceiver unit 12 (e.g., a transceiver circuit).

In a design, the transceiver unit 12 is configured to receive a first OBSS frame on a primary channel. The processing unit 11 is configured to determine a first channel with a busy channel state based on bandwidth information carried in the first OBSS frame, where any sub-channel of the first channel may not be used together with a second channel, and the second channel is a channel to which the primary channel is switched. The first channel includes the primary channel.

Optionally, the processing unit 11 is further configured to perform channel contention when switching from the primary channel to the second channel, and determine, after backing off to 0 on the second channel, a third channel used for transmitting data, where the third channel does not include any sub-channel of the first channel.

Optionally, the processing unit 11 is further configured to update a first NAV on the primary channel based on a duration field in the first OBSS frame received by the transceiver unit 12.

It should be understood that the communication device in this design may correspondingly perform Embodiment I, and the foregoing operations or functions of the various units in the communication device are separately used to implement the corresponding operations of the communication device in Embodiment I. For brevity, details are not described herein again.

In a design, the transceiver unit 12 is configured to perform, when a channel state of a primary channel is a busy state, switching from the primary channel to a second channel, and receive a second OBSS frame on the second channel, where channels corresponding to a bandwidth of the second OBSS frame include the primary channel. The processing unit 11 is configured to update, if a time length indicated by a duration field in the second OBSS frame is greater than a current time length of a first NAV on the primary channel, the first NAV based on the duration field in the second OBSS frame.

Optionally, the transceiver unit 12 is further configured to receive a first OBSS frame on the primary channel. The processing unit 11 is further configured to update the first NAV on the primary channel based on a duration field in the first OBSS frame.

Optionally, the processing unit 11 is further configured to perform switching from the second channel to the primary channel or to a fourth channel.

Optionally, the processing unit 11 is further configured to: set a second NAV on the second channel based on the duration field in the second OBSS frame; and perform switching from the second channel to the primary channel or a fourth channel when the time length indicated by the duration field in the second OBSS frame is equal to the current time length of the first NAV.

Optionally, the processing unit 11 is further configured to perform switching from the second channel to a fourth channel. After the TXOP is obtained on the fourth channel, end time of the TXOP on the fourth channel may not exceed end time of a TXOP on the primary channel.

Optionally, the processing unit 11 is further configured to: when the TXOP is obtained on the fourth channel, if a value of the second NAV is greater than 0, determine that channels used for transmitting data do not include any sub-channel of the channel corresponding to the bandwidth of the first OBSS frame or any sub-channel of the channel corresponding to the bandwidth of the second OBSS frame; and when the TXOP is obtained on the fourth channel, if a value of the second NAV is equal to 0, determine that channels used for transmitting data do not include any sub-channel of the channel corresponding to the bandwidth of the first OBSS frame.

It should be understood that the communication device in this design may correspondingly perform Embodiment II, and the foregoing operations or functions of the various units in the communication device are separately used to implement the corresponding operations of the communication device in Embodiment II. For brevity, details are not described herein again.

In a possible design, the processing unit 11 is configured to perform, when a channel state of a primary channel is a busy state, switching from the primary channel to a second channel, and determine a value of a CW and an initial value of a BOC on the second channel. The value of the CW on the second channel is equal to a current value of a CW on the primary channel, and the initial value of the BOC on the second channel is equal to a current value of a BOC on the primary channel. Alternatively, the value of the CW on the second channel is a minimum CW value CWmin, and the initial value of the BOC on the second channel is an integer selected from 0 to CWmin.

Optionally, the transceiver unit 12 is configured to receive a first OBSS frame on the primary channel. The processing unit 11 is further configured to update the first NAV on the primary channel based on a duration field in the first OBSS frame.

Optionally, a result of energy detection performed by the processing unit 11 on the primary channel is a busy state.

It should be understood that the communication device in this design may correspondingly perform Embodiment III, and the foregoing operations or functions of the various units in the communication device are separately used to implement the corresponding operations of the communication device in Embodiment III. For brevity, details are not described herein again.

In a design, the processing unit 11 is configured to perform energy detection on the primary channel after switching from a second channel back to a primary channel, where the second channel is a channel to which the primary channel is switched; and perform first processing on the primary channel when an energy detection result on the primary channel within a first time is a busy state. The first processing includes: performing channel contention at an interval of a second time after the channel state of the primary channel changes from the busy state to an idle state; or setting, within preset time, an energy detection threshold used for CCA on the primary channel to be a value less than -62 dBm, and sending an RTS frame after a backoff counter on the primary channel backs off to 0.

Optionally, the transceiver unit 12 is configured to receive a first OBSS frame on the primary channel. The processing unit 11 is further configured to update the first NAV on the primary channel based on a duration field in the first OBSS frame.

Optionally, the processing unit 11 is further configured to perform the first processing on the primary channel if time of switching from the second channel back to the primary channel is later than time at which the first NAV on the primary channel changes to 0.

Optionally, the first time may start at the time of switching from the second channel back to the primary channel until the end of a PIFS when the first NAV on the primary channel decreases to 0. The second time may be an EIFS.

It should be understood that the communication device in this design may correspondingly perform Embodiment IV, and the foregoing operations or functions of the various units in the communication device are separately used to implement the corresponding operations of the communication device in Embodiment IV. For brevity, details are not described herein again.

In a design, the processing unit 11 is configured to perform switching from the primary channel to the second channel when a result of energy detection performed on the primary channel is a busy state. The processing unit 11 is further configured to perform switching back to the primary channel within a third time. Alternatively, the processing unit 11 is further configured to: when time for leaving the primary channel exceeds a fourth time, set, within preset time after the switching back from the second channel to the primary channel, an energy detection threshold used for CCA on the primary channel to be a value less than -62 dBm, and send an RTS frame after a backoff counter on the primary channel backs off to 0. Alternatively, the processing unit 11 is further configured to: when time for leaving the primary channel exceeds a fourth time and does not exceed a third time, set, within preset time after the switching back from the second channel to the primary channel, an energy detection threshold used for CCA on the primary channel to be a value less than -62 dBm, and send an RTS frame after a backoff counter on the primary channel backs off to 0.

The third time does not exceed a TXOP limit or a maximum PPDU length. The time for leaving the primary channel starts from the time for leaving the primary channel and ends at the time of switching back to the primary channel.

It should be understood that the communication device in this design may correspondingly perform Embodiment V, and the foregoing operations or functions of the various units in the communication device are separately used to implement the corresponding operations of the communication device in Embodiment V. For brevity, details are not described herein again.

The foregoing describes the communication device in some embodiments, and the following describes possible product forms of the communication device. It should be understood that any product in any form that has the functions of the communication device in FIG. 10 falls within the protection scope of embodiments of this application. It should be further understood that the following description is merely an example, and a product form of the communication device in some embodiments is not limited thereto.

As a possible product form, the communication device in some embodiments may be implemented by using a general bus architecture.

The communication device includes a processor and a transceiver that is internally connected to and communicates with the processor.

In a design, the transceiver is configured to receive a first OBSS frame on a primary channel. The processor is configured to determine a first channel with a busy channel state based on bandwidth information carried in the first OBSS frame, where any sub-channel of the first channel may not be used together with a second channel, and the second channel is a channel to which the primary channel is switched.

In a design, the processor is configured to perform, when a channel state of a primary channel is a busy state, switching from the primary channel to a second channel. The transceiver is configured to receive a second OBSS frame on the second channel, where channels corresponding to a bandwidth of the second OBSS frame include the primary channel. The processor is further configured to update, if a time length indicated by a duration field in the second OBSS frame is greater than a current time length of a first NAV on the primary channel, the first NAV based on the duration field in the second OBSS frame.

In a design, the processor is configured to perform, when a channel state of a primary channel is a busy state, switching from the primary channel to a second channel, and determine a value of a CW and an initial value of a BOC on the second channel. The value of the CW on the second channel is equal to a current value of a CW on the primary channel, and the initial value of the BOC on the second channel is equal to a current value of a BOC on the primary channel. Alternatively, the value of the CW on the second channel is a minimum CW value CWmin, and the value of the BOC on the second channel is an integer selected from 0 to CWmin.

In a design, the processor is configured to perform energy detection on the primary channel after switching from a second channel back to a primary channel, where the second channel is a channel to which the primary channel is switched; and perform first processing on the primary channel when a result of the energy detection on the primary channel within a first time is a busy state. The first processing includes: performing channel contention at an interval of a second time after the channel state of the primary channel changes from the busy state to an idle state; or setting, within a preset time, an energy detection threshold used for CCA on the primary channel to be a value less than -62 dBm, and sending a request to send an RTS frame after a backoff counter on the primary channel backs off to 0.

In a design, the processor is configured to perform switching from the primary channel to the second channel when a result of energy detection performed by the communication device on the primary channel is a busy state. The processor is further configured to perform switching back to the primary channel within third time. Alternatively, the processor is further configured to: when time for leaving the primary channel exceeds a fourth time, set, within a preset time after the switching from the second channel back to the primary channel, an energy detection threshold used for CCA on the primary channel to be a value less than -62 dBm, and send an RTS frame after a backoff counter on the primary channel backs off to 0. Alternatively, the processor is further configured to: when time for leaving the primary channel exceeds a fourth time and does not exceed a third time, set, within preset time after the switching from the second channel back to the primary channel, an energy detection threshold used for CCA on the primary channel to be a value less than -62 dBm, and send an RTS frame after a BOC on the primary channel backs off to 0.

A chip for implementing the communication device includes a processing circuit and an input/output interface that is internally connected to and communicates with the processing circuit.

In a design, the input/output interface is configured to receive the first OBSS frame received by a transceiver from a primary channel. The processing circuit is configured to determine a first channel with a busy channel state based on bandwidth information carried in the first OBSS frame, where any sub-channel of the first channel may not be used together with a second channel, and the second channel is a channel to which the primary channel is switched.

In a possible design, the processor is configured to perform, when a channel state of a primary channel is a busy state, switching from the primary channel to a second channel. The input/output interface is configured to receive the second OBSS frame received by the transceiver from the second channel. The processing circuit is further configured to update, if a time length indicated by a duration field in the second OBSS frame is greater than a current time length of a first NAV on the primary channel, the first NAV based on the duration field in the second OBSS frame.

In a design, the processing circuit is configured to perform, when a channel state of a primary channel is a busy state, switching from the primary channel to a second channel, and determine a value of a CW and an initial value of a BOC on the second channel. The value of the CW on the second channel is equal to a current value of a CW on the primary channel, and the initial value of the BOC on the second channel is equal to a current value of a BOC on the primary channel. Alternatively, the value of the CW on the second channel is a minimum CW value CWmin, and the value of the BOC on the second channel is an integer selected from 0 to CWmin.

In a design, the processing circuit is configured to perform energy detection on the primary channel after switching from a second channel back to a primary channel, where the second channel is a channel to which the primary channel is switched; and perform first processing on the primary channel when a result of the energy detection on the primary channel within a first time is a busy state. The first processing includes: performing channel contention at an interval of a second time after the channel state of the primary channel changes from the busy state to an idle state; or setting, within preset time, an energy detection threshold used for CCA on the primary channel to be a value less than -62 dBm, and sending an RTS frame after a BOC on the primary channel backs off to 0.

In a design, the processing circuit is configured to perform switching from the primary channel to the second channel when a result of energy detection performed on the primary channel is a busy state. The processing circuit is further configured to perform switching back to the primary channel within a third time. Alternatively, the processing circuit is further configured to: when time for leaving the primary channel exceeds a fourth time, set, within preset time after the switching from the second channel back to the primary channel, an energy detection threshold used for CCA on the primary channel to be a value less than -62 dBm, and send an RTS frame after a BOC on the primary channel backs off to 0. Alternatively, the processing circuit is further configured to: when time for leaving the primary channel exceeds a fourth time and does not exceed a third time, set, within a preset time after the switching from the second channel back to the primary channel, an energy detection threshold used for CCA on the primary channel to be a value less than -62 dBm, and send an RTS frame after a BOC on the primary channel backs off to 0.

As a possible product form, the communication device in some embodiments may be further implemented by using the following components: one or more FPGAs (field programmable gate arrays), a PLD (programmable logic device), a controller, a state machine, a gate logic, a discrete hardware component, any other suitable circuit, or any combination of circuits that can perform various functions described through this application.

It should be understood that the communication devices in the foregoing various product forms have any function in the foregoing method embodiments, and details are not described herein again.

An embodiment of this application further provides a computer-readable storage medium. The computer-readable storage medium stores instructions. When the instructions are on a computer, the computer is enabled to perform the method in any one of the foregoing embodiments.

An embodiment of this application further provides a computer program product. When the computer program product is run on a computer, the computer is enabled to perform the method in any one of the foregoing embodiments.

An embodiment of this application further provides a communication apparatus. The apparatus may exist in a product form of a chip. A structure of the apparatus includes a processor and an interface circuit. The processor is configured to communicate with another apparatus through the interface circuit, to enable the apparatus to perform the method in any one of the foregoing embodiments.

Method or algorithm steps described in combination with the content disclosed in this application may be implemented by hardware, or may be implemented by a processor by executing software instructions. The software instructions may include a corresponding software module. The software module may be stored in a random access memory (RAM), a flash memory, an erasable programmable read-only memory (EPROM), an electrically erasable programmable read-only memory (EEPROM), a register, a hard disk, a removable hard disk, a compact disc read-only memory (CD-ROM), or any other form of storage medium well-known in the art. For example, a storage medium is coupled to a processor, so that the processor can read information from the storage medium and write information into the storage medium. Certainly, the storage medium may be a component of the processor. The processor and the storage medium may be disposed in an application-specific integrated circuit (ASIC). In addition, the ASIC may be located in a core network interface device. Certainly, the processor and the storage medium may exist in the core network interface device as discrete components.

A person skilled in the art should be aware that in the foregoing one or more examples, functions described in this application may be implemented by hardware, software, firmware, or any combination thereof. When the functions are implemented by software, the foregoing functions may be stored in a computer-readable medium or transmitted as one or more instructions or code in a computer-readable medium. The computer-readable medium includes a computer-readable storage medium and a communication medium. The communication medium includes any medium that facilitates transmission of a computer program from one place to another. The storage medium may be any available medium accessible to a general-purpose or a dedicated computer.

In the foregoing specific implementations, the objectives, technical solutions, and beneficial effects of this application are further described in detail. It should be understood that the foregoing descriptions are merely specific implementations of this application, but are not intended to limit the protection scope of this application. Any modification, equivalent replacement, improvement, or the like made based on the technical solutions of this application shall fall within the protection scope of this application.

1. A communication apparatus, comprising:
at least one processor; and
one or more memories coupled to the at least one processor and storing instructions for execution by the at least one processor to perform operations comprising:
receiving, a first overlapping basic service set (OBSS) frame on a primary channel; and
determining, a first channel with a busy channel state based on bandwidth information carried in the first OBSS frame, wherein any sub-channel of the first channel may not be used together with a second channel, and the second channel is a channel to which the primary channel is switched to.

2. The communication apparatus according to claim 1, wherein after the determining, the first channel with the busy channel state based on the bandwidth information carried in the first OBSS frame, the operations further comprise:
performing, channel contention when switching from the primary channel to the second channel; and
after the communication apparatus backs off to 0 on the second channel, determining, a third channel used for transmitting data, wherein the third channel does not comprise any of the sub-channels of the first channel.

3. The communication apparatus according to claim 1, wherein the first channel is a channel corresponding to a bandwidth indicated by the bandwidth information in the first OBSS frame.

4. The communication apparatus according to claim 1, wherein a bandwidth of the first OBSS frame is 320 MHz; and
the first channel is a 160 MHz channel at which a 320 MHz channel corresponding to the bandwidth of the first OBSS frame and a 320 MHz channel supported by the communication apparatus overlap in frequency.

5. A communication apparatus, comprising:
at least one processor; and
one or more memories coupled to the at least one processor and storing instructions for execution by the at least one processor to perform operations that comprise:
when a channel state of a primary channel is a busy state, performing, switching from the primary channel to a first channel, and receiving a first overlapping basic service set (OBSS) frame on the first channel, wherein channels corresponding to a bandwidth of the first OBSS frame comprise the primary channel; and
when a time length indicated by a duration field in the first OBSS frame is greater than a current time length of a first network allocation vector (NAV) on the primary channel, updating, the first NAV based on the duration field in the first OBSS frame.

6. The communication apparatus according to claim 5, wherein that the channel state of the primary channel is the busy state, and wherein the operations further comprise: receiving, a second OBSS frame on the primary channel, and updating the first NAV on the primary channel based on a duration field in the second OBSS frame.

7. The communication apparatus according to claim 5, wherein the operations further comprise:
performing, switching from the first channel to the primary channel or to a third channel.

8. The communication apparatus according to claim 5, wherein the operations further comprise:
setting, a second NAV on the first channel based on the duration field in the first OBSS frame; and
when the time length indicated by the duration field in the first OBSS frame is equal to the current time length of the first NAV, performing, switching from the first channel to the primary channel or to the third channel.

9. The communication apparatus according to claim 8, wherein after the setting, the second NAV on the first channel based on the duration field in the first OBSS frame, the operations further comprise:
performing, switching from the first channel to the third channel; and
after the communication apparatus obtains a transmission opportunity (TXOP) on the third channel, an end time of the TXOP on the third channel does not exceed an end time of a TXOP on the primary channel.

10. The communication apparatus according to claim 9, wherein the operations further comprise:
when the communication apparatus obtains the TXOP on the third channel, when a value of the second NAV is greater than 0, determining, that channels used for transmitting data do not comprise any sub-channel of a channel corresponding to a bandwidth of the second OBSS frame or any sub-channel of the channel corresponding to the bandwidth of the first OBSS frame; or
when the communication apparatus obtains the TXOP on the third channel, when a value of the second NAV is equal to 0, determining, that channels used for transmitting data do not comprise any sub-channel of a channel corresponding to a bandwidth of the second OBSS frame.

11. A communication apparatus, comprising:
at least one processor; and
one or more memories coupled to the at least one processor and storing instructions for execution by the at least one processor to perform operations that comprise:
when a channel state of a primary channel is a busy state, performing, switching from the primary channel to a first channel, and determining a value of a contention window (CW) on the first channel and an initial value of a backoff counter (BOC), wherein
the value of the CW on the first channel is equal to a current value of a CW on the primary channel, and the initial value of the BOC on the first channel is equal to a current value of a BOC on the primary channel; or
the value of the CW on the first channel is a minimum CW value CWmin, and the initial value of the BOC on the first channel is an integer selected from 0 to CWmin.

12. The communication apparatus according to claim 11, wherein that the channel state of the primary channel is the busy state, the operations further comprise:
receiving, a first OBSS frame on the primary channel, and updating a first network allocation vector (NAV) on the primary channel based on a duration field in the first OBSS frame; or
a result of energy detection performed by the communication apparatus on the primary channel is a busy state.

13. The communication apparatus according to claim 12, wherein the first channel is a channel corresponding to a bandwidth indicated by the bandwidth information in the first OBSS frame.

14. The communication apparatus according to claim 12, wherein a bandwidth of the first OBSS frame is 320 MHz; and
the first channel is a 160 MHz channel at which a 320 MHz channel corresponding to the bandwidth of the first OBSS frame and a 320 MHz channel supported by the communication apparatus overlap in frequency.

15. The communication apparatus according to claim 11, wherein the operations further comprise:
performing, switching from the first channel to the primary channel or to a third channel.

16. The communication apparatus according to claim 12, wherein the operations further comprise:
setting, a second NAV on the first channel based on the duration field in the first OBSS frame; and
when the time length indicated by the duration field in the first OBSS frame is equal to the current time length of the first NAV, performing, switching from the first channel to the primary channel or to a third channel.

17. The communication apparatus according to claim 16, wherein after the setting, the second NAV on the first channel based on the duration field in the first OBSS frame, the operations further comprise:
performing, switching from the first channel to the third channel; and
after the communication apparatus obtains a transmission opportunity (TXOP) on the third channel, end time of the TXOP on the third channel does not exceed end time of a TXOP on the primary channel.

18. The communication apparatus according to claim 16, wherein the operations further comprise:
when the communication apparatus obtains the TXOP on the third channel, when a value of the second NAV is greater than 0, determining, that channels used for transmitting data do not comprise any sub-channel of a channel corresponding to a bandwidth of a second OBSS frame or any sub-channel of the channel corresponding to the bandwidth of the first OBSS frame; or
when the communication apparatus obtains the TXOP on the third channel, when a value of the second NAV is equal to 0, determining, that channels used for transmitting data do not comprise any sub-channel of a channel corresponding to a bandwidth of the second OBSS frame.
